(19) United States
(12) Patent Application Publication
(10) Pub. No.: US 2025/0184869 A1
(43) Pub. Date: Jun. 5, 2025

(54) ROUTE SELECTION PROCESS FOR HANDLING CONGESTION WITH RELAY PROXIMITY-BASED SERVICES

(71) Applicant: Telefonaktiebolaget LM Ericsson (publ), Stockholm (SE)

(72) Inventors: Antonio INIESTA GONZALEZ, Madrid (ES); Miguel Angel MUÑOZ DE LA TORRE ALONSO, Madrid (ES); Zhang FU, Stockholm (SE); Maria Belen PANCORBO MARCOS, MADRID (ES)

(73) Assignee: Telefonaktiebolaget LM Ericsson (publ), Stockholm (SE)

(21) Appl. No.: 18/842,801

(22) PCT Filed: Mar. 29, 2023
(86) PCT No.: PCT/IB2023/053139

§ 371 Date: Aug. 30, 2024

(30) Foreign Application Priority Data
Mar. 29, 2022 (EP) 22382299.0

(51) Int. Cl. H04W 48/06; H04W 16/18; H04W 28/02; H04W 28/12; H04W 88/04

(52) U.S. Cl. CPC H04W 48/06; H04W 16/18; H04W 28/0284; H04W 28/12; H04W 88/04

(57) ABSTRACT

A method, system and apparatus are disclosed. A core network node configured to communicate with a first wireless device (WD) is described. The first WD is configurable to indirectly communicate with one or both of the core network node and a network node at least via at least one other WD. The at least one other WD is configured to perform relay communication. The core network node includes processing circuitry configured to determine that a first coverage area meets a predefined criterion and cause transmission to the first WD of a first indication. The first indication is based on the first coverage area meeting the predefined criterion for restricting any other WD associated with the first coverage area from being used by the first WD to indirectly communicate with one or both of the core network node and the network node.

### TECHNICAL FIELD

The present disclosure relates to wireless communications, and in particular, to Proximity-based Services (ProSe) relay selection.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and wireless devices (WD) (such as User Equipment (UE)), as well as communication between network nodes and between WDs. Sixth Generation (6G) wireless communication systems are also under development.

### Reference Architecture

FIG. 1 is an example from 3GPP such as from 3GPP Technical Specification (TS) 23.304 which shows the high-level view of the non-roaming 5G System architecture for Proximity-based Services (ProSe) with service-based interfaces within the Control Plane. In this figure, UE A (e.g., wireless device A) and UE B (wireless device B) use a subscription of the same public land mobile network (PLMN).

### 5G ProSe UE-to-Network Relay

3GPP such as, for example, Clause 5.4 of 3GPP TS 23.304 describes 5G ProSe UE-to-Network Relay, which is detailed below.

### 5G ProSe Layer-3 UE-to-Network Relay

### General

The 5G ProSe Layer-3 UE-to-Network Relay provides generic function that can relay any internet protocol (IP), Ethernet or Unstructured traffic:
For IP traffic over proximity-based communication interface 5 (PC5) reference point, the 5G ProSe Layer-3 UE-to-Network Relay uses IP type packet data unit (PDU) Session towards 5G Core (5GC).
For Ethernet traffic over PC5 reference point, the 5G ProSe Layer-3 UE-to-Network Relay can use Ethernet type PDU Session or IP type PDU Session towards 5GC.
For Unstructured traffic over PC5 reference point, the 5G ProSe Layer-3 UE-to-Network Relay can use Unstructured type PDU Session or IP type PDU Session (i.e. IP encapsulation/de-capsulation by 5G ProSe Layer-3 UE-to-Network Relay) towards 5GC.

The type of traffic supported over PC5 reference point is indicated by the 5G ProSe Layer-3 UE-to-Network Relay, e.g., using the corresponding relay service code (RSC). The 5G ProSe Layer-3 UE-to-Network Relay determines the PDU Session Type based on configuration of the mapping between PDU Session parameters and RSC, as specified in 3GPP such as in clause 5.1.4.1 of 3GPP TS 23.304.

IP type PDU Session and Ethernet type PDU Session can be used to support more than one 5G ProSe Layer-3 Remote UEs while Unstructured type PDU Session can be used to support only one 5G ProSe Layer-3 Remote UE.

The maximum number of PDU Sessions can affect the maximum number of 5G ProSe Layer-3 Remote UEs that the 5G ProSe UE-to-Network Relay can support.

5G ProSe Layer-3 UE-to-Network Relay with N3IWF Support

To support 5G ProSe Layer-3 Remote UE services with end-to-end confidentiality and internet protocol (IP) address preservation requirements, the 5G ProSe Layer-3 UE-to-Network Relay with Non 3GPP Inter Working Function (N3IWF) provides access to the 5GC for the 5G ProSe Layer-3 Remote UE via N3IWF using the features defined in 3GPP such as in, for example, clause 4.2.8 of 3GPP TS 23.501.

5G ProSe Layer-3 UE-to-Network Relay is provisioned with RSC(s) and the corresponding PDU session parameters (e.g., S-NSSAI) to support N3IWF access as part of 5G ProSe Layer-3 UE-to-Network Relay Policy/parameters. When a 5G ProSe Layer-3 Remote UE connects with the corresponding RSC, the 5G ProSe Layer-3 UE-to-Network Relay determines the corresponding PDU session parameters based on the requested RSC.

NOTE: The 5G ProSe Layer-3 UE-to-Network Relay only includes a RSC in discovery message when the corresponding PDU session parameters (e.g., S-NSSAI) are authorized to be used in the accessed network.

The 5G ProSe Layer-3 Remote UE selects N3IWF as specified by the 3GPP. The selection of N3IWF follows the regulatory rules of the country where it is located, and when required by the regulations the 5G ProSe Layer-3 Remote UE only selects a N3IWF within the local country. Quality of service (QoS) differentiation can be provided on per-IPsec Child Security Association basis and the details are provided by the 3GPP.

The 5GC to which the 5G ProSe Layer-3 UE-to-Network Relay registers and the 5GC to which the 5G ProSe Layer-3 Remote UE registers may be in the same PLMN or different PLMN.

### 5G ProSe Layer-2 UE-to-Network Relay

The 5G ProSe Layer-2 UE-to-Network Relay provides forwarding functionality that can relay any type of traffic over the PC5 link.

The 5G ProSe Layer-2 UE-to-Network Relay provides the functionality to support connectivity to the 5GS for 5G ProSe Layer-2 Remote UEs. A UE is considered to be a 5G ProSe Layer-2 Remote UE if it has successfully established a PC5 link to the 5G ProSe Layer-2 UE-to-Network Relay. A 5G ProSe Layer-2 Remote UE can be located within NG-RAN coverage or outside of NG-RAN coverage.

For 5G ProSe UE-to-Network Relay Discovery, the standalone discovery is used, and both Model A and Model B are supported.

For PLMN selection and relay selection in the 5G ProSe Layer-2 Remote UE:
The 5G ProSe Layer-2 Remote UE checks whether the PLMN(s) supported by the serving cell of the 5G ProSe Layer-2 UE-to-Network Relay(s) are authorized to be connected to via a 5G ProSe Layer-2 UE-to-Network Relay(s), and only the authorized PLMN(s) are then available PLMNs for NAS PLMN selection;
The 5G ProSe Layer-2 Remote UE selects the 5G ProSe Layer-2 UE-to-Network Relay considering the selected PLMN by NAS layer.

### 5G ProSe UE-to-Network Relay Communication Functional Flows

3GPP such as, for example, Clause 6.5 of 3GPP TS 23.304 describes 5G ProSe UE-to-Network Relay Communication functional flows:

5G ProSe Communication Via 5G ProSe Layer-3 UE-to-Network Relay without N3IWF

A 5G ProSe Layer-3 UE-to-Network Relay registers to the network (if not already registered). 5G ProSe Layer-3 UE-to-Network Relay establishes a PDU Session(s) or modifies an existing PDU Session(s) in order to provide relay traffic towards 5G ProSe Layer-3 Remote UE(s). PDU Session(s) supporting 5G ProSe Layer-3 UE-to-Network Relay may only be used for 5G ProSe Layer-3 Remote UE(s) relay traffic.

The PLMN serving the 5G ProSe Layer-3 UE-to-Network Relay and the PLMN to which the 5G ProSe Layer-3 Remote UE registers can be the same PLMN or two different PLMNs.

FIG. 2 is a diagram of an example 5G ProSe communication via 5G ProSe layer-3 UE-to-Network Relay without N3IWF. Steps illustrated in FIG. 2 are discussed below.

1. Service authorization and provisioning are performed for the 5G ProSe Layer-3 UE-to-Network Relay (step 1a) and 5G ProSe Layer-3 Remote UE (step 1b) as described by the 3GPP.

2. The 5G ProSe Layer-3 UE-to-Network Relay may establish a PDU Session for relaying. In the case of IPv6, the 5G ProSe Layer-3 UE-to-Network Relay obtains the IPv6 prefix via prefix delegation function from the network as defined in 3GPP such as in, for example, 3GPP TS 23.501.

NOTE 1: 5G ProSe Layer-3 UE-to-Network Relay can establish a PDU Session for any Relay Service Code it supports before the connection is established with the 5G ProSe Layer-3 Remote UE.

3. The 5G ProSe Layer-3 Remote UE performs discovery of a 5G ProSe Layer-3 UE-to-Network Relay as described by the 3GPP. As part of the discovery procedure the 5G ProSe Layer-3 Remote UE learns about the connectivity service the 5G ProSe Layer-3 UE-to-Network Relay provides.

4. The 5G ProSe Layer-3 Remote UE selects a 5G ProSe Layer-3 UE-to-Network Relay and establishes a connection for unicast mode communication as described by 3GPP. If there is no PDU Session associated with the Relay Service Code or a new PDU Session for relaying is needed, the 5G ProSe Layer-3 UE-to-Network Relay initiates a new PDU Session establishment procedure for relaying before completing the PC5 connection establishment.

The network decides that the PDU session to be established is for relay traffic, and then generates the QoS rules and QoS Flow level QoS parameters to 5G ProSe Layer-3 UE-to-Network Relay with relay consideration as specified by the.

The 5G ProSe Layer-3 UE-to-Network Relay determines the PDU Session type for relaying as specified by the 3GPP.

According to the PDU Session Type for relaying, the 5G ProSe Layer-3 UE-to-Network Relay performs relaying function at the corresponding layer as follows:
When the IP type PDU Session is used for IP traffic over PC5 reference point, the 5G ProSe Layer-3 UE-to-Network Relay acts as an IP router. For IPv4, the 5G ProSe Layer-3 UE-to-Network Relay performs IPv4 NAT between IPv4 addresses assigned to the 5G ProSe Layer-3 Remote UE and the IPv4 address assigned to the PDU Session used for the relay traffic.
When the Ethernet type PDU Session is used for Ethernet traffic over PC5 reference point, the 5G ProSe Layer-3 UE-to-Network Relay acts as an Ethernet switch.
When the Unstructured type PDU Session is used for Unstructured traffic over PC5 reference point, the 5G ProSe Layer-3 UE-to-Network Relay performs traffic relaying based on a mapping between the PC5 Link Identifier and the PDU Session ID, and a mapping between PFI for PC5 Layer-2 link and the QFI for the PDU Session. These mappings are created when the Unstructured type PDU Session is established for the 5G ProSe Layer-3 Remote UE.
When the IP type PDU Session is used for Ethernet or Unstructured traffic over PC5 reference point, the 5G ProSe Layer-3 UE-to-Network Relay uses IP tunneling. For this IP tunnelling, the 5G ProSe Layer-3 UE-to-Network Relay locally assigns an IP address/prefix for the 5G ProSe Layer-3 Remote UE and uses it on the Uu reference point to encapsulate and decapsulate the uplink and downlink traffic for the 5G ProSe Layer-3 Remote UE. The tunneled traffic over Uu reference point is transported over the PC5 reference point as Ethernet or Unstructured traffic.
5. For IP PDU Session Type and IP traffic over PC5 reference point, IPv6 prefix or IPv4 address (including NAT case) is allocated for the 5G ProSe Layer-3 Remote UE as defined by the 3GPP.
6. The 5G ProSe Layer-3 Remote UE may provide the PC5 QoS rule to the 5G ProSe Layer-3 UE-to-Network Relay using Layer-2 link modification procedure as specified by the 3GPP. The 5G ProSe Layer-3 UE-to-Network Relay generates the Packet Filters used over Uu interface based on the received PC5 QoS Rule(s) as described by the 3GPP by the, and may perform the UE requested PDU Session Modification as defined in 3GPP such as in, for example, 3GPP TS 23.502 clause 4.3.3 to setup a new QoS Flow or bind the traffic to an existing QoS Flow.

From this point the uplink and downlink relaying can start. For downlink traffic forwarding, the PC5 QoS Rule is used to map the downlink packet to the PC5 QoS Flow. For uplink traffic forwarding, the 5G QoS Rule is used to map the uplink packet to the Uu QoS Flow.

7. The 5G ProSe Layer-3 UE-to-Network Relay sends a Remote UE Report (Remote User ID, Remote UE info) message to the SMF for the PDU Session associated with the relay. The Remote User ID is an identity of the 5G ProSe Layer-3 Remote UE user that was successfully connected in step 4. The Remote UE info is used to assist identifying the 5G ProSe Layer-3 Remote UE in the 5GC. For IP PDU Session Type, the Remote UE info is Remote UE IP info. For Ethernet PDU Session Type, the Remote UE info is Remote UE MAC address which is detected by the 5G ProSe Layer-3 UE-to-Network Relay. For Unstructured PDU Session Type, the Remote UE info is not included. The SMF stores the Remote User IDs and the related Remote UE info in the 5G ProSe Layer-3 UE-to-Network Relay's SM context for this PDU Session associated with the relay.

The Remote UE Report is N1 SM NAS message sent with the PDU Session ID to the AMF (e.g., AMF 104), in turn delivered to the SMF.

NOTE 2: The privacy protection for Remote User ID depends on SA WG3 design.

For IP info the following principles may apply:
for IPv4, the 5G ProSe Layer-3 UE-to-Network Relay reports TCP/UDP port ranges assigned to individual 5G ProSe Layer-3 Remote UE(s) (along with the Remote User ID);
for IPv6, the 5G ProSe Layer-3 UE-to-Network Relay reports IPv6 prefix(es) assigned to individual 5G ProSe Layer-3 Remote UE(s) (along with the Remote User ID).

If the PDU Session for relaying is released by the UE-to-Network Relay or the network as described in 3GPP such as in, for example, clause 4.3.4 of 3GPP TS 23.502, the UE-to-Network Relay should initiate the release of the layer-2 links associated with the released PDU Session using the procedure defined by the 3GPP.

The PDU Session(s) used for relaying may be released as described in 3GPP such as in, for example, clause 4.3.4 of 3GPP TS 23.502 (e.g., by 5G ProSe Layer-3 UE-to-Network Relay), if the service authorization for acting as a 5G ProSe Layer-3 UE-to-Network Relay in the serving PLMN is revoked.

The 5G ProSe Layer-3 UE-to-Network Relay sends the Remote UE Report message when the 5G ProSe Layer-3 Remote UE disconnects from the 5G ProSe Layer-3 UE-to-Network Relay (e.g., upon explicit layer-2 link release or based on the absence of keep alive messages over PC5) to inform the SMF that the 5G ProSe Layer-3 Remote UE(s) have left.

NOTE 3: In order for the SMF to have the 5G ProSe Layer-3 Remote UE(s) information, the HPLMN and the VPLMN where the 5G ProSe Layer-3 UE-to-Network Relay is authorized to operate, needs to support the transfer of the 5G ProSe Layer-3 Remote UE related parameters if the SMF is in the HPLMN.

It is up to 5G ProSe Layer-3 UE-to-Network Relay implementation as to how PDU Session(s) used for relaying are released or QoS Flow(s) used for relaying are removed by the 5G ProSe Layer-3 UE-to-Network Relay when 5G ProSe Layer-3 Remote UE(s) disconnect from the 5G ProSe Layer-3 UE-to-Network Relay.

5G ProSe Communication Via 5G ProSe Layer-3 UE-to-Network Relay with N3IWF Support
Connection Management Via 5G ProSe Layer-3 UE-to-Network Relay with N3IWF Support

In order to relay 5G ProSe Layer-3 Remote UE's traffic via N3IWF, the 5G ProSe Layer-3 UE-to-Network Relay may need suitable ProSe Policies configured for establishing a PDU Session associated with a UPF that conveys the traffic towards the N3IWF. 5G ProSe Layer-3 UE-to-Network Relay registers to the network as specified by the 3GPP. Based on configuration and authorization, the 5G ProSe Layer-3 UE-to-Network Relay is provisioned with PDU Session parameters in the ProSe Policy allowing the access to the N3IWF. When the corresponding PDU Session is established, the 5GS, e.g., SMF, based on the parameters (i.e., DNN, S-NSSAI) selects the UPF that ensures the connection to the N3IWF. The UPF for the 5G ProSe UE-to-Network Relay and the N3IWF may be collocated.

A 5G ProSe Layer-3 UE-to-Network Relay with a PDU Session providing access via N3IWF may also have other PDU Sessions for supporting access from the 5G ProSe Layer-3 Remote UE without going through a N3IWF.

NOTE 1: Whether different PDU Sessions need to be established to serve traffics for Layer-3 Remote UE with or without going through a N3IWF is determined by Layer-3 Relay UE as described in 3GPP such as in, for example, 3GPP TS 23.503 V17.4.0.

FIG. 3 is a diagram of connection establishment over 5G ProSe Layer-3 UE-to-Network Relay with N3IWF support. The steps of FIG. 3 are described below.

1. 5G ProSe Layer-3 UE-to-Network Relay performs Registration procedures and obtains the ProSe Policy that corresponds to the operation supporting the access to N3IWF. The ProSe Policy includes the RSC and PDU Session parameters allowing the access to the N3IWF.

The 5G ProSe Layer-3 Remote UE is configured with the corresponding ProSe Policy and URSP rules. The URSP policy indicates if a particular service needs to be accessed within a PDU Session and thus may use a 5G ProSe Layer-3 UE-to-Network Relay with N3IWF support as described by the 3GPP by the.

2-4. A 5G ProSe Layer-3 UE-to-Network Relay and 5G ProSe Layer-3 Remote UE follow the procedures described in steps 3-5, for example using the RSC configured for making the 5G ProSe Layer-3 Remote UE access to 5GC via N3IWF.

NOTE 2: The services requiring the access via N3IWF can be configured with the RSC(s) that can be served by the same 5G ProSe UE-to-Network Relay.

5. The 5G ProSe Layer-3 Remote UE that connects to a 5G ProSe Layer-3 UE-to-Network Relay with N3IWF support selects an N3IWF and determines the N3IWF IP address. The 5G ProSe Layer-3 Remote UE follows the N3IWF selection procedure as described by the 3GPP.

6. The 5G ProSe Layer-3 Remote UE establishes a signaling IPsec tunnel using IKE procedures with a N3IWF and performs NAS Registration as shown in FIG. 4.12.2.2-1 of 3GPP TS 23.502. After the Internet Protocol SECure transmission (IPSec) tunnel is established, the 5G ProSe Layer-3 Remote UE can perform any of the NAS procedures (including PDU Session establishment for the 5G ProSe Layer-3 UE-to-Network Relay PDU Sessions) as specified in 3GPP such as, for example, clause 4.12 of 3GPP TS 23.502.

7. After the PDU session(s) and associated QoS Flows are established in the 5G ProSe Layer-3 Remote UE's 5GC, the N3IWF determines the number of IPsec Child SA(s) that is needed and initiates the creation of the Child SA(s) as specified in 3GPP such as in, for example, clause 4.12.5 of 3GPP TS 23.502. Once the Child SA(s) has been created, the 5G ProSe Layer 3 Remote UE will have the mapping between the DSCP markings for the IPsec Child SA(s), the corresponding QoS, and N3IWF IP address(es) and provides this information, if needed, to the 5G ProSe Layer-3 UE-to-Network Relay as specified by the 3GPP. If needed, the 5G ProSe Layer-3 UE-to-Network Relay performs the PDU Session Modification procedure to request QoS flow(s) configuration that maps to the 5G ProSe Layer-3 Remote UE's Child SA(s).

Internet key exchange (IKE) keep alive(s) between the 5G ProSe Layer-3 Remote UE and the N3IWF are used for detecting possible path failure. The 5G ProSe Layer-3 Remote UE may change 5G ProSe Layer-3 UE-to-Network Relay(s) while maintain the session with the N3IWF when the 5G ProSe Layer-3 Remote UE and the N3IWF support MOBility and multihoming extension of IKE (MOBIKE). This is negotiated between the 5G ProSe Layer-3 Remote UE and the N3IWF as specified in 3GPP such as in, for example, 3GPP TS 23.502, clause 4.12.2.2). When IKE keep alive(s) are used, the 5G ProSe Layer-3 Remote UE needs to keep the PC5 connection and 5G ProSe Layer-3 UE-to-Network Relay keeps the PDU Session.

When 5G ProSe Remote UE is in CM-CONNECTED state, the 5G ProSe Remote UE keeps the PC5 link. When the 5G ProSe Remote UE is in CM-IDLE state, it may either release the PC5 link for relaying or not.

### Additional Parameters Announcement Procedure

Additional parameters announcement procedure illustrated in FIG. 4 is used by a 5G ProSe Remote UE to request a 5G ProSe UE-to-Network Relay to announce additional parameters (for model A) as defined in 3GPP such as in, for example, clause 5.8.3 of 3GPP. The steps of FIG. 4 are described below.

1. 5G ProSe Remote UE has discovered a 5G ProSe UE-to-Network Relay and requires additional parameters.

2. The 5G ProSe Remote UE sends to the 5G ProSe UE-to-Network Relay an Additional Parameters Announcement Request to obtain additional parameters.

3. The 5G ProSe UE-to-Network Relay acknowledges receipt of the request in step 2 with an Additional Parameters Announcement Response (Additional_Parameters_Announcement_Request_Refresh Timer). The Additional_Parameters_Announcement_Request_Refresh Timer (configurable in the 5G ProSe UE-to-Network Relay), is provided to the 5G ProSe Remote UE so that when this timer expires the 5G ProSe Remote UE repeats the Additional Parameters Announcement Request procedure if it still needs to obtain the additional parameters. If the 5G ProSe Remote UE does not initiate new Additional Parameters Announcement Request procedure when this Additional_Parameters_AnnouncementRequest_Refresh Timer expires and no other UE request additional parameters announcement before the Additional_Parameters_AnnouncementLRequest_Refresh timer expires in the 5G ProSe UE-to-Network Relay, then the relay shall stop announcing the additional parameters.

4. The 5G ProSe UE-to-Network Relay announces the additional parameters by sending Relay Discovery Additional Information message as defined by the 3GPP. This is repeated periodically with a configurable frequency (normally higher than the one related to the Additional_Parameters_AnnouncementRequest_Refresh Timer) until there is no UE requesting to announce the additional parameters as determined by the Additional_Parameters_AnnouncementLRequest_Refresh Timer running in the 5G ProSe UE-to-Network Relay.

NOTE: Based on UE implementation, the 5G ProSe UE-to-Network Relay can send the Relay Discovery Additional Information message several times consecutively in step 4 of FIG. 4 if there are other 5G ProSe Remote UE(s) that have connected to the 5G ProSe UE-to-Network Relay but not yet requested any additional parameters. This ensures the other 5G ProSe Remote UE(s) obtain such additional parameters without invoking any new request(s).

5. The 5G ProSe UE-to-Network Relay detects new or updated additional parameters.

6. Detection of new or updated additional parameters in step 5 of FIG. 4 triggers the 5G ProSe UE-to-Network Relay to announce the additional parameters by sending a Relay Discovery Additional Information Message immediately and to repeat it periodically with a configurable frequency as in step 4 of FIG. 4 until there are no UEs requesting to announce the additional parameters, i.e., until the Additional_Parameters_Announcement_Request_Refresh Timer expires in the 5G ProSe UE-to-Network Relay.

### 5G ProSe Remote UE Traffic Handling for 5G ProSe UE-to-Network Relay Support

For the 5G ProSe Remote UE to access the service via 5G ProSe UE-to-Network Relay, the following apply:
The application traffic on the 5G ProSe Remote UE is managed by URSP rules (with consideration of local configurations), following the procedure defined in 3GPP such as in, for example, clauses 6.1.2.2.1 and 6.6.2.3 of 3GPP TS 23.503. The URSP rules defined in 3GPP such as in, for example, clause 6.6.2.1 of 3GPP TS 23.503 applies for the 5G ProSe Remote UE, with RSD enhanced to include:
a new “5G ProSe Layer-3 UE-to-Network Relay Offload indication”.
If a software application or application traffic matches a URSP rule, corresponding RSDs are used to evaluate the existing PDU sessions, or establish a new PDU session, or determine to offload outside of a PDU session.
If the selected RSD contains “5G ProSe Layer-3 UE-to-Network Relay Offload indication”, the 5G ProSe Remote UE routes the traffic to the 5G ProSe Layer-3 UE-to-Network Relay connection without establishing a PDU session, when such connection is available.

This may trigger the 5G ProSe Remote UE to start 5G ProSe UE-to-Network Relay discovery if it is not yet started. The discovery and establishment of the connection with the 5G ProSe Layer-3 UE-to-Network Relay is controlled by the ProSe Policy (pre-) configured on the 5G ProSe Remote UE.
If the matched URSP rule contains both a RSD with “Non-Seamless Offload indication” and a RSD with “5G ProSe Layer-3 UE-to-Network Relay Offload indication”, whether to offload the traffic to non-3GPP access or the 5G ProSe Layer-3 UE-to-Network Relay connection depends on the priority of the RSDs, and the availability of the connections, as specified in 3GPP such as in, for example, the clause 6.6.2.3 of 3GPP TS 23.503 V17.4.0.

If the selected RSD does not contain the “5G ProSe Layer-3 UE-to-Network Relay Offload indication” or, “Non-Seamless Offload indication”, the 5G ProSe Remote UE uses a PDU session to route the corresponding application traffic.

If configured in the ProSe Policy, the 5G ProSe Remote UE may attempt the discovery of a Relay Service Code corresponding to a 5G ProSe Layer-3 UE-to-Network Relay with N3IWF support in the discovery procedure, when the non-3GPP access type is preferred in the selected RSD. The 5G ProSe Remote UE may attempt the discovery of a Relay Service Code corresponding to a 5G ProSe Layer-2 UE-to-Network Relay in the discovery procedure, when the 3GPP access type is preferred in the selected RSD.
If the 5G ProSe Remote UE has an indirect connection via a 5G ProSe Layer-2 UE-to-Network Relay connection available, it may be treated as the “3GPP” access type. If the 5G ProSe Remote UE has an indirect connection via a 5G ProSe Layer-3 UE-to-Network Relay with N3IWF support available, it may be treated as the “non-3GPP” access type. The URSP handling as defined in 3GPP such as in, for example, 3GPP TS 23.503 V17.4.0 applies.

For the 5G ProSe Layer-3 UE-to-Network Relay and 5G ProSe Layer-2 UE-to-Network Relay, the URSP handling does not apply to the relayed traffic from the 5G ProSe Remote UE.

For the 5G ProSe Layer-3 UE-to-Network Relay, the PDU session established for relaying the 5G ProSe Remote UE's traffic is controlled by the ProSe Policy.

### URSP Content

The content of the URSP is described in 3GPP such as in, for example, 3GPP TS 23.503 V17.4.0, section 6.6.2.1 a portion of which is described below. In particular, below is described information included for the Route Selection Descriptor in that section (including the ProSe Layer-3 UE-to-Network Relay Offload indication):

TABLE 1
Content of URSP. The acronym UE may refer to a WD.

| | | | PCF | |
|---|---|---|---|---|
| | | | permitted | |
| Information | | | to modify | |
| name | Description | Category | in URSP | Scope |
| Route | Determines the order | Mandatory | Yes | UE |
| Selection | in which the Route | (NOTE 1) | | context |
| Descriptor | Selection Descriptors | | | |
| Precedence | are to be applied. | | | |
| Route | This part defines the | Mandatory | | |
| selection | route selection | (NOTE 2) | | |
| components | components | | | |
| SSC Mode | One single value of | Optional | Yes | UE |
| Selection | SSC mode. | | | context |
| | (NOTE 5) | | | |
| Network | Either a single value | Optional | Yes | UE |
| Slice | or a list of values of | (NOTE 3) | | context |
| Selection | S-NSSAI(s). | | | |
| DNN | Either a single value | Optional | Yes | UE |
| Selection | or a list of values of | | | context |
| | DNN(s). | | | |
| PDU Session | One single value of | Optional | Yes | UE |
| Type | PDU Session Type | (NOTE 8) | | context |
| Selection | | | | |
| Non- | Indicates if the traffic | Optional | Yes | UE |
| Seamless | of the matching | (NOTE 4) | | context |
| Offload | application is to be | | | |
| indication | offloaded to non- | | | |
| | 3GPP access outside | | | |
| | of a PDU Session. | | | |
| ProSe Layer- | Indicates if the traffic | Optional | Yes | UE |
| 3 UE-to- | of the matching | (NOTE 4) | | context |
| Network | application is to be | | | |
| Relay | sent via a ProSe | | | |
| Offload | Layer-3 UE-to- | | | |
| indication | Network Relay | | | |
| | outside of a PDU | | | |
| | session. | | | |
| Access Type | Indicates the | Optional | Yes | UE |
| preference | preferred Access | | | context |
| | Type (3GPP or non- | | | |
| | 3GPP or Multi- | | | |
| | Access) when the UE | | | |
| | establishes a PDU | | | |
| | Session for the | | | |
| | matching application. | | | |
| PDU Session | An indication shared | Optional | Yes | UE |
| Pair ID | by redundant PDU | | | context |
| | Sessions as described | | | |
| | in clause 5.33.2.1 of | | | |
| | TS 23.501 [2]. | | | |
| RSN | The RSN as described | Optional | Yes | UE |
| | in clause 5.33.2.1 of | | | context |
| | TS 23.501 [2]. | | | |
| Route | This part defines the | Optional | | |
| Selection | Route Validation | | | |
| Validation | Criteria components | | | |
| Criteria | | | | |
| (NOTE 6) | | | | |
| Time | The time window | Optional | Yes | UE |
| Window | when the matching | | | context |
| | traffic is allowed. The | | | |
| | RSD is not | | | |
| | considered to be valid | | | |
| | if the current time is | | | |
| | not in the time | | | |
| | window. | | | |
| Location | The UE location | Optional | Yes | UE |
| Criteria | where the matching | | | context |
| | traffic is allowed. The | | | |
| | RSD rule is not | | | |
| | considered to be valid | | | |
| | if the UE location | | | |
| | does not match the | | | |
| | location criteria. | | | |

(NOTE 1):
Every Route Selection Descriptor in the list may have a different precedence value.
(NOTE 2):
At least one of the route selection components may be present.
(NOTE 3):
When the Subscription Information contains only one S-NSSAI in UDR, the policy control function (PCF) needs not provision the UE with S-NSSAI in the Network Slice Selection information. The “match all” URSP rule has one S-NSSAI at most.
(NOTE 4):
If this indication is present in a Route Selection Descriptor, no other components may be included in the Route Selection Descriptor.
(NOTE 5):
The SSC Mode 3 shall only be used when the PDU Session Type is IP.
(NOTE 6):
The Route Selection Descriptor is not considered valid unless all the provided Validation Criteria are met.
NOTE 7:
In this Release of specification, inclusion of the Validation Criteria in Roaming scenarios is not considered.
(NOTE 8):
When the PDU Session Type is “Ethernet” or “Unstructured”, this component shall be present. In table ProSe Layer-3 UE-to-Network Relay Offload indication: Indicates that the traffic of the matching application is to be sent via a ProSe Layer-3 UE-to-Network Relay outside of a PDU Session when the rule is applied. If this indication is absent then the traffic matching of the URSP rule may not be sent via a ProSe Layer-3 UE-to-Network Relay outside of a PDU Session. If this component is present in a Route Selection Descriptor, no other components may be included in the Route Selection Descriptor.

### SUMMARY

Some embodiments advantageously provide methods, systems, and apparatuses for Proximity-based Services (ProSe) relay (ProSe relay WD) selection, configuration, etc., such as actions associated with ProSe relay WD selection, configuration.

One or more embodiments described herein provide a mechanism which solves at least part of the problem in existing systems and allows the network (PCF) to enable ProSe indirect communication for a WD but adding some restrictions for the ProSe Relay WDs to use for the indirect communication. Therefore, the network may restrict the ProSe indirect communication through the ProSe Relay WDs that are located in the same congested cell as the Remote WD and allow it for ProSe Relay WDs that are in a non-congested cell.

The idea is based on an extension of WD Route Selection Policy (URSP) ProSe Relay offload indication to enable the PCF to provide the restricted locations for the ProSe Relay WDs to use with ProSe indirect communication.

The PCF may get the information about the congested locations by, for example, receiving “User Data Congestion” analytics from NWDAF and using this information to fill the restricted locations for the ProSe Relay WDs in the extended URSP ProSe Relay Offload indication for Remote WDs in the congested area.

In addition, the Remote WD needs to understand this extension of the URSP including the restricted locations, and then filter the list of discovered candidates for ProSe Relay WDs to the ones matching the location condition.

Alternatively, when PCF receives “User Data Congestion” analytics, it knows which area will be or is congested, PCF may update the ProSe policy to the relay WD in that area, so that those relay WDs will not act as relay WD, therefore the remote WD can only connect to the relay in non-congested area.

According to one aspect of the present disclosure, a node configured to communicate with a remote user equipment, UE, is provided. The node configured to, and/or comprising a radio interface and/or comprising processing circuitry configured to determine whether at least one ProSe UE is associated with at least one coverage area meeting a predefined criterion, and cause transmission of at least one restriction based on the determination that the at least one coverage area meets the predefined criterion, the at least one restriction being associated with selecting a ProSe relay UE for indirect communication.

According to another aspect of the present disclosure, a remote user equipment, UE, configured to communicate with a node where the remote UE configured to, and/or comprising a radio interface and/or processing circuitry configured to receive at least one restriction associated with selecting a ProSe relay UE for indirect communication, and select a first ProSe relay UE based on the at least one restriction.

According to another aspect of the present disclosure, a method implemented by a node configured to communicate with a remote user equipment, UE, is provided. The method includes: determining whether at least one ProSe UE is associated with at least one coverage area meeting a predefined criterion; and causing transmission of at least one restriction based on the determination that the at least one coverage area meets the predefined criterion, the at least one restriction being associated with selecting a ProSe relay UE for indirect communication.

According to another aspect of the present disclosure, a method implemented by a remote user equipment, UE, configured to communicate with a node is provided. The method includes receiving at least one restriction associated with selecting a ProSe relay UE for indirect communication; and selecting a first ProSe relay UE based on the at least one restriction.

According to one aspect, a core network node configured to communicate with a first wireless device (WD) is described. The first WD is configurable to indirectly communicate with one or both of the core network node and a network node at least via at least one other WD. The at least one other WD is configured to perform relay communication. The core network node comprises processing circuitry configured to determine that a first coverage area meets a predefined criterion and cause transmission to the first WD of a first indication. The first indication is based on the first coverage area meeting the predefined criterion for restricting any other WD associated with the first coverage area from being used by the first WD to indirectly communicate with one or both of the core network node and the network node.

In some embodiments, the processing circuitry is further configured to determine that a second coverage area does not meet the predefined criterion. The first indication is transmitted further based on the determination that the second coverage area does not meet the predefined criterion. The first indication further enables the first WD to indirectly communicate with one or both of the core network node and the network node via any other WD associated with the second coverage area.

In some other embodiments, the first indication triggers the first WD to switch from a WD currently being used as a relay WD by the first WD in the first coverage area to another WD in the second coverage area to be used by the first WD as the relay WD to indirectly communicate with one or both of the core network node and the network node.

In some embodiments, the processing circuitry is further configured to determine that the first WD is authorized to use another WD to indirectly communicate with one or both of the core network node and the network node, determine one or more other WDs have not been activated to perform relay communication, and determine a second indication that triggers the first WD to activate relay communication via one or more other WDs associated with the second coverage area.

In some other embodiments, the processing circuitry is further configured to cause transmission of the second indication to the first WD, the second indication further indicating that data is to be transmitted outside a packet data unit (PDU) session, using the activated indirect communication.

In some embodiments, meeting the predefined criterion comprises reaching or exceeding a network congestion threshold.

In some other embodiments, the first indication further indicates at least the first coverage area as a restricted location for WDs to perform relay communication.

In some embodiments, the core network node is a policy control function (PCF) node, the network node is an access network node, the first WD is a remote WD, and the first WD and the at least one other WD are configured to communicate using Proximity-based Services (ProSe).

In some other embodiments, the processing circuitry is further configured to cause transmission of a third indication different from the first indication to at least one other WD in the first coverage area to trigger the at least one other WD to stop performing relay communication.

In some embodiments, the processing circuitry is further configured to receive network congestion analytics from a network data analytics function (NWDAF) node. The determination that the first coverage area meets the predefined criterion is based at least on the received network congestion analytics.

According to another aspect, a method in a core network node configured to communicate with a first wireless device (WD) is described. The first WD is configurable to indirectly communicate with one or both of the core network node and a network node at least via at least one other WD. The at least one other WD is configured to perform relay communication. The method comprises determining that a first coverage area meets a predefined criterion and transmitting to the first WD a first indication. The first indication is based on the first coverage area meeting the predefined criterion for restricting any other WD associated with the first coverage area from being used by the first WD to indirectly communicate with one or both of the core network node and the network node.

In some embodiments, the method further comprises determining that a second coverage area does not meet the predefined criterion. The first indication is transmitted further based on the determination that the second coverage area does not meet the predefined criterion. The first indication further enables the first WD to indirectly communicate with one or both of the core network node and the network node via any other WD associated with the second coverage area.

In some other embodiments, the first indication triggers the first WD to switch from a WD currently being used as a relay WD by the first WD in the first coverage area to another WD in the second coverage area to be used by the first WD as the relay WD to indirectly communicate with one or both of the core network node and the network node.

In some embodiments, the method further comprises determining that the first WD is authorized to use another WD to indirectly communicate with one or both of the core network node and the network node, determining one or more other WDs have not been activated to perform relay communication, and determining a second indication that triggers the first WD to activate relay communication via one or more other WDs associated with the second coverage area.

In some other embodiments, the method further includes transmitting the second indication to the first WD, the second indication further indicating that data is to be transmitted outside a packet data unit (PDU) session, using the activated indirect communication.

In some embodiments, meeting the predefined criterion comprises reaching or exceeding a network congestion threshold.

In some other embodiments, the first indication further indicates at least the first coverage area as a restricted location for WDs to perform relay communication.

In some embodiments, the core network node is a policy control function (PCF) node, the network node is an access network node, the first WD is a remote WD, and the first WD and the at least one other WD are configured to communicate using Proximity-based Services (ProSe).

In some other embodiments, the method further comprises transmitting a third indication different from the first indication to at least one other WD in the first coverage area to trigger the at least one other WD to stop performing relay communication.

In some embodiments, the method further comprises receiving network congestion analytics from a network data analytics function (NWDAF) node. The determination that the first coverage area meets the predefined criterion is based at least on the received network congestion analytics.

According to one aspect, a first wireless device (WD) configurable to indirectly communicate with one or both of a core network node and a network node at least via at least one other WD is described. The at least one other WD is configured to perform relay communication. The first WD comprising processing circuitry configured to receive a first indication. The first indication is based on a first coverage area meeting a predefined criterion for restricting any other WD associated with the first coverage area from being used by the first WD to indirectly communicate with one or both of the core network node and the network node. Another WD that is not in the first coverage area is selected to indirectly communicate with one or both of the core network node and the network node based on the first indication.

In some embodiments, the first indication is further based on a determination that a second coverage area does not meet the predefined criterion. The first indication further enables the first WD to indirectly communicate with one or both of the core network node and the network node via any other WD associated with the second coverage area.

In some other embodiments, the processing circuitry is further configured to switch, based on the first indication, from a WD currently being used as a relay WD by the first WD in the first coverage area to another WD in the second coverage area to be used by the first WD as the relay WD to indirectly communicate with one or both of the core network node and the network node.

In some embodiments, the first WD is authorized to use another WD to indirectly communicate with one or both of the core network node and the network node, one or more other WDs have not been activated to perform relay communication, and the processing circuitry is further configured to receive a second indication that triggers the first WD to activate relay communication via one or more other WDs associated with the second coverage area and activate the relay communication via the one or more other WDs associated with the second coverage area based on the second indication.

In some other embodiments, the second indication further indicates that data is to be transmitted outside a packet data unit (PDU) session, using the activated indirect communication.

In some other embodiments, meeting the predefined criterion comprises reaching or exceeding a network congestion threshold.

In some embodiments, the first indication further indicates at least the first coverage area as a restricted location for WDs to perform relay communication.

In some other embodiments, the core network node is a policy control function (PCF) node, the network node is an access network node, the first WD is a remote WD, and the first WD and the at least one other WD are configured to communicate using Proximity-based Services (ProSe).

In some embodiments, the processing circuitry is further configured to receive a third indication different from the first indication to at least one other WD in the first coverage area to trigger the at least one other WD to stop performing relay communication.

In some other embodiments, the first coverage area meeting the predefined criterion is based on network congestion analytics determined by a network data analytics function (NWDAF) node.

According to another aspect, a method in a first wireless device (WD) configurable to indirectly communicate with one or both of a core network node and a network node at least via at least one other WD is described. The at least one other WD is configured to perform relay communication. The method comprises receiving a first indication. The first indication is based on a first coverage area meeting a predefined criterion for restricting any other WD associated with the first coverage area from being used by the first WD to indirectly communicate with one or both of the core network node and the network node and selecting another WD that is not in the first coverage area to indirectly communicate with one or both of the core network node and the network node based on the first indication.

In some embodiments, the first indication is further based on a determination that a second coverage area does not meet the predefined criterion. The first indication further enables the first WD to indirectly communicate with one or both of the core network node and the network node via any other WD associated with the second coverage area.

In some other embodiments, the method further comprises switching, based on the first indication, from a WD currently being used as a relay WD by the first WD in the first coverage area to another WD in the second coverage area to be used by the first WD as the relay WD to indirectly communicate with one or both of the core network node and the network node.

In some embodiments, the first WD is authorized to use another WD to indirectly communicate with one or both of the core network node and the network node, one or more other WDs have not been activated to perform relay communication, and the method further comprises receiving a second indication that triggers the first WD to activate relay communication via one or more other WDs associated with the second coverage area and activating the relay communication via the one or more other WDs associated with the second coverage area based on the second indication.

In some other embodiments, the second indication further indicates that data is to be transmitted outside a packet data unit (PDU) session, using the activated indirect communication.

In some embodiments, meeting the predefined criterion comprises reaching or exceeding a network congestion threshold.

In some other embodiments, the first indication further indicates at least the first coverage area as a restricted location for WDs to perform relay communication.

In some embodiments, the core network node is a policy control function (PCF) node, the network node is an access network node, the first WD is a remote WD, and the first WD and the at least one other WD are configured to communicate using Proximity-based Services (ProSe).

In some other embodiments, the method further comprises receiving a third indication different from the first indication to at least one other WD in the first coverage area to trigger the at least one other WD to stop performing relay communication.

In some embodiments, the first coverage area meeting the predefined criterion is based on network congestion analytics determined by a network data analytics function (NWDAF) node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a 5G reference architecture of policy and charging control framework;

FIG. 2 is a signaling diagram of 5G ProSe communication via 5G ProSe layer-3 UE-to-network relay without N3IWF;

FIG. 3 is a signaling diagram of a connection establishment over 5G ProSe layer-3 UE-to-Network relay with N3IWF support;

FIG. 4 is a signaling diagram of additional parameters announcement procedure;

FIG. 5 is a schematic diagram of an example network architecture illustrating a communication system connected via an intermediate network to a host computer according to the principles in the present disclosure;

FIG. 6 is a block diagram of a host computer communicating via a network node with a WD over an at least partially wireless connection according to some embodiments of the present disclosure;

FIG. 7 is a flowchart illustrating example methods implemented in a communication system including a host computer, a network node and a WD for executing a client application at a WD according to some embodiments of the present disclosure;

FIG. 8 is a flowchart illustrating example methods implemented in a communication system including a host computer, a network node and a WD for receiving user data at a WD according to some embodiments of the present disclosure;

FIG. 9 is a flowchart illustrating example methods implemented in a communication system including a host computer, a network node and a WD for receiving user data from the WD at a host computer according to some embodiments of the present disclosure;

FIG. 10 is a flowchart illustrating example methods implemented in a communication system including a host computer, a network node and a WD for receiving user data at a host computer according to some embodiments of the present disclosure;

FIG. 11 is a flowchart of an example process in a node according to some embodiments of the present disclosure;

FIG. 12 is a flowchart of an example process in a WD according to some embodiments of the present disclosure;

FIG. 13 is a flowchart of another example process in a node according to some embodiments of the present disclosure;

FIG. 14 is a flowchart of another example process in a WD according to some embodiments of the present disclosure;

FIG. 15 is shows an example WD configured to select one or more relay WDs according to some embodiments of the present disclosure;

FIG. 16 is a signaling diagram of an example selection of a relay WD based on congestion according to some embodiments of the present disclosure; and

FIG. 17 is a signaling diagram another example selection of a relay WD based on congestion according to some embodiments of the present disclosure.

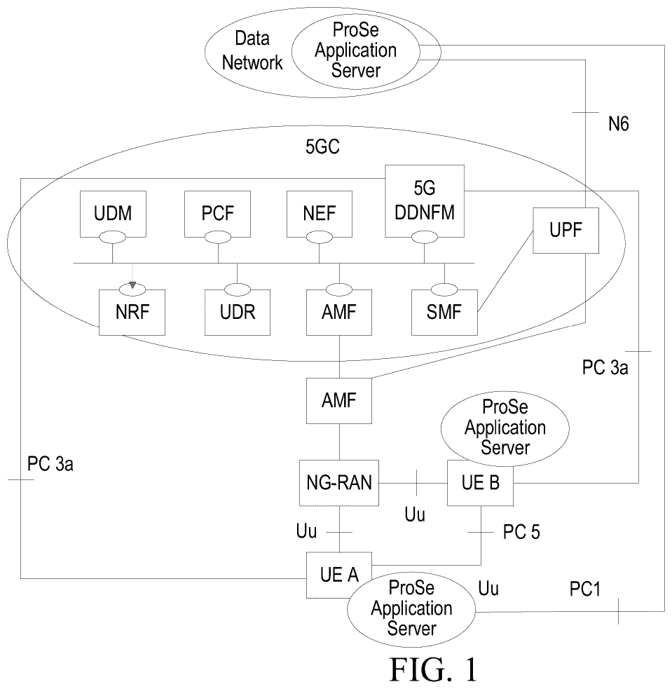

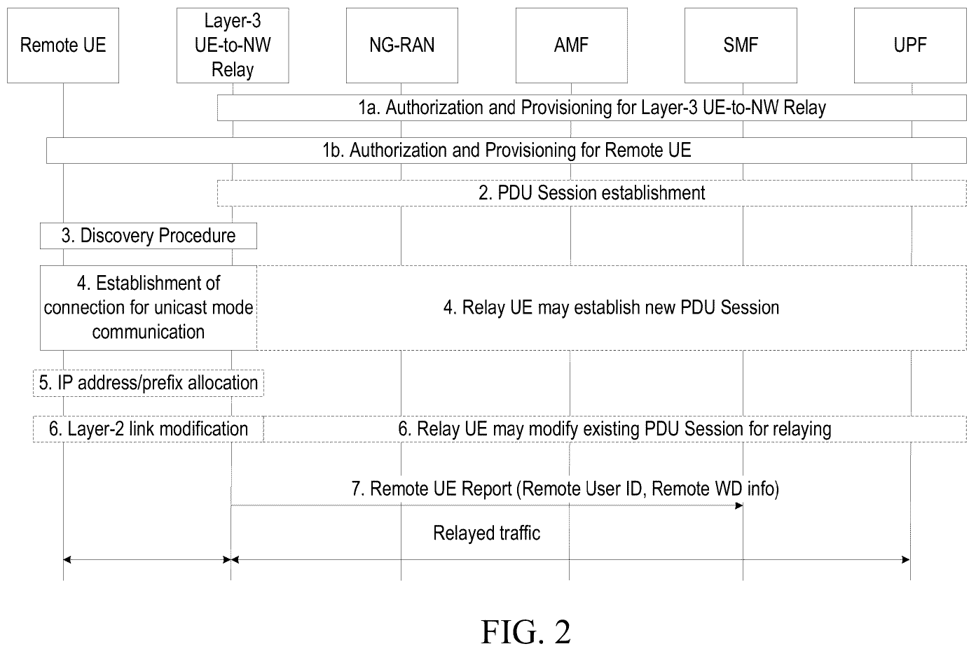

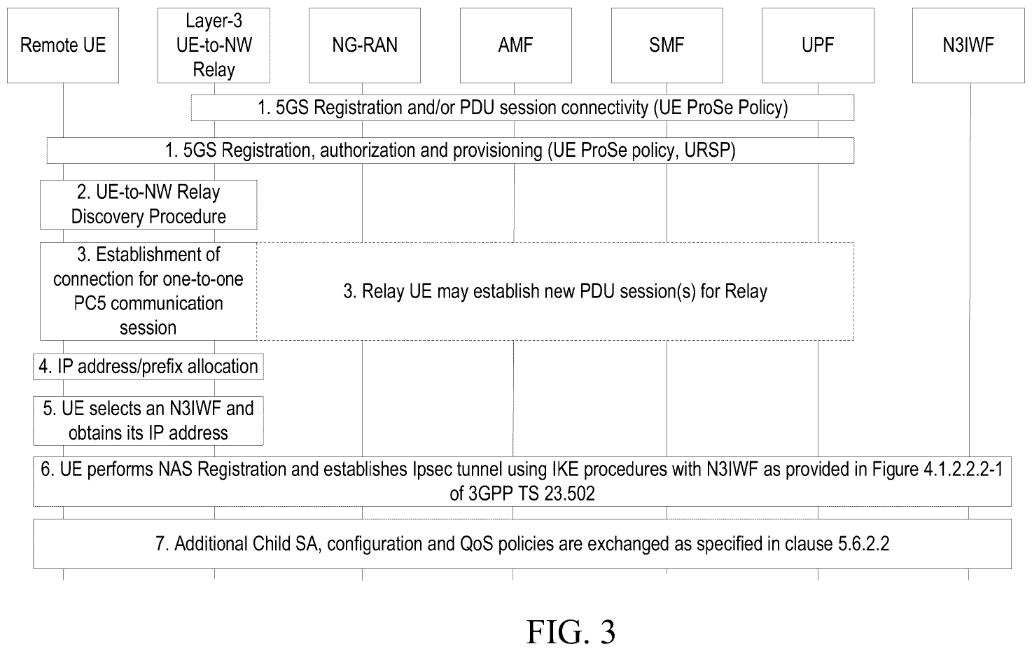

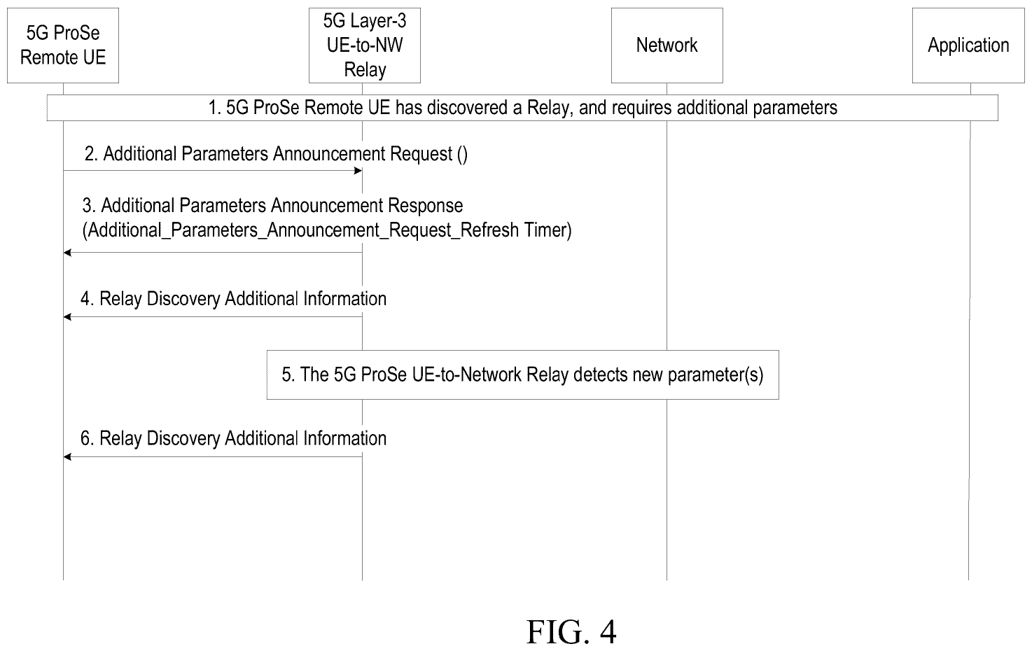

### DETAILED DESCRIPTION

Before describing in detail example embodiments, it is noted that the embodiments reside primarily in combinations of apparatus components and processing steps related to relay WD selection (e.g., ProSe relay WD selection) and/or configuration. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a user equipment (UE) or wireless device or a radio network node.

In some embodiments, the non-limiting terms wireless device (WD) or a user equipment (UE) are used interchangeably. The WD herein can be any type of wireless device capable of communicating with a network node or another WD over radio signals. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc. A WD may further comprise a remote WD and a relay WD. In some embodiments, a remote WD may refer to a WD that is not in direct communication with a network node (e.g., an access network node such as a gNB) or a core node. The remote WD may be configured to indirectly communicate with the network node or core node such as via a relay WD, e.g., a ProSe relay WD.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a WD or a network node may be distributed over a plurality of WDs and/or network nodes. In other words, it is contemplated that the functions of the network node and WD described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide ProSe relay WD selection, configuration, etc.

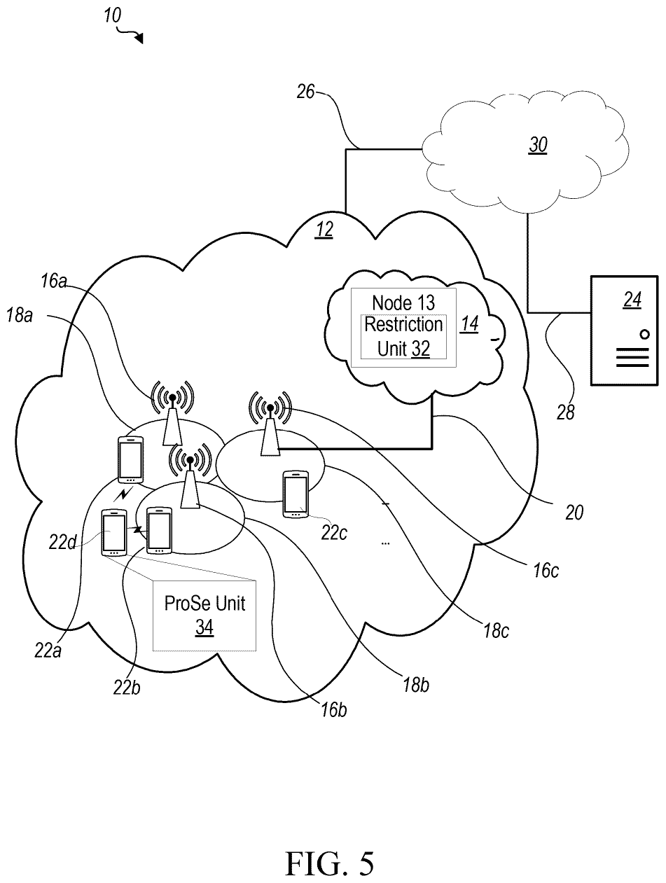

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first user equipment (UE) 22a located in coverage area 18a is configured to wirelessly connect to, or be paged by, the corresponding network node 16a. A second WD 22b in coverage area 18b is wirelessly connectable to the corresponding network node 16b. A third WD 22c in coverage area 18c is wirelessly connectable to the corresponding network node 16c. WD 22d may a remote WD 22 that is located outside of coverage area 18b such that remote WD 22 may be searching for a ProSe relay WD 22 (e.g., WD 22b) as described herein. While a plurality of WDs 22a, 22b (collectively referred to as WDs 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16. WDs 22a-22d may be capable or configured to support ProSe communications with each other or at least one other WD 22.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14 including node 13 (may be referred to as core network node 13), any intermediate network 30 and possible further infrastructure (not shown) as intermediaries. Node 13 is configured to include restriction unit 32 which is configured to perform one or more node 13 functions as described herein such as with respect to ProSe relay selection, configuration, etc. Node 13 may be referred to as a core network node and may comprise one or more network nodes and/or functions associated with a core network such as a PCF. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A WD 22 (e.g., WD 22d) is configured to include a ProSe unit 34 which is configured to perform one or more WD 22 functions as described herein such as with respect to ProSe selection, etc.

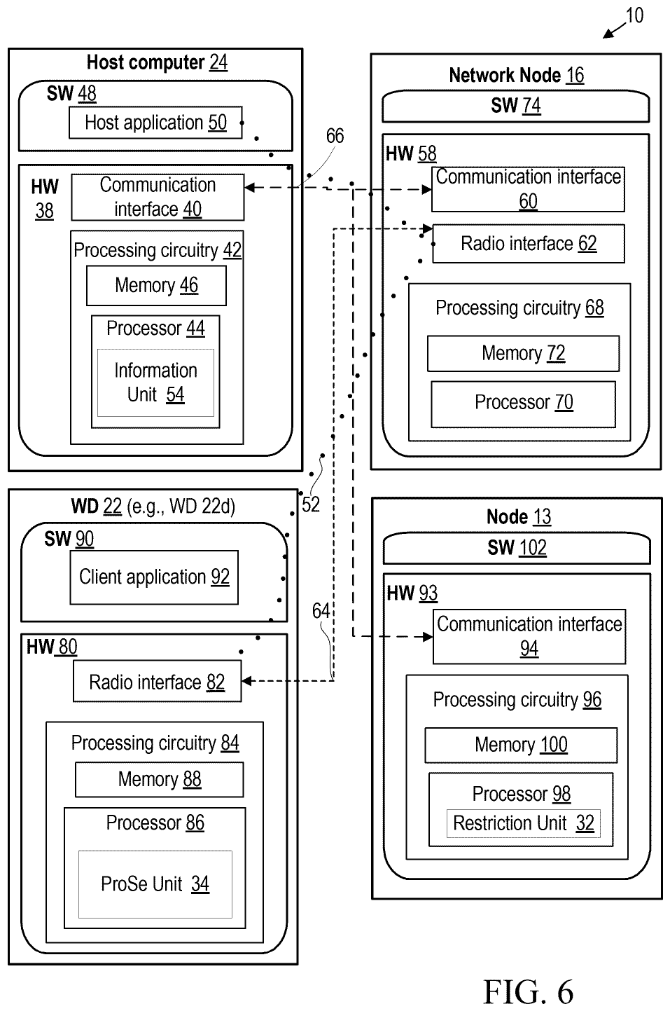

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16, node 13 and or the WD 22. The processing circuitry 42 of the host computer 24 may include an information unit 54 configured to enable the service provider to determine, relay, forward, transmit, analyze, receive, communicate, store, etc. information related to ProSe selection, configuration, etc. as described herein.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the WD 22 may include a ProSe unit 34 configured to perform one or more WD 22 functions described herein such as with respect to ProSe selection, etc.

The communication system 10 further includes a node 13 (e.g., PCF node) provided in a communication system 10 and including hardware 93 enabling it to communicate with the network node 16 and with the WD 22, via for example network node 16. The communication interface 60 may be configured to facilitate a connection 66 to the host computer 24 and/or network node 16. The connection 66 may be direct or it may pass through a core network 14 of the communication system 10 and/or through one or more intermediate networks 30 outside the communication system 10.

In the embodiment shown, the hardware 93 of the node 13 further includes processing circuitry 96. The processing circuitry 96 may include a processor 98 and a memory 100. In particular, in addition to or instead of a processor, such as a central processing unit, and memory, the processing circuitry 96 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 98 may be configured to access (e.g., write to and/or read from) the memory 100, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the node 13 further has software 102 stored internally in, for example, memory 100, or stored in external memory (e.g., database, storage array, network storage device, etc.) accessible by the node 13 via an external connection. The software 102 may be executable by the processing circuitry 96. The processing circuitry 96 may be configured to control any of the methods and/or processes described herein and/or to cause such methods, and/or processes to be performed, e.g., by node 13. Processor 98 corresponds to one or more processors 98 for performing node 13 functions described herein. The memory 100 is configured to store data, programmatic software code and/or other information described herein. In some embodiments, the software 102 may include instructions that, when executed by the processor 98 and/or processing circuitry 96, causes the processor 98 and/or processing circuitry 96 to perform the processes described herein with respect to node 13. For example, processing circuitry 96 of the node 13 may include restriction unit 32 configured to perform one or more node 13 functions as described herein such as with respect to ProSe relay WD selection, configuration, etc.

In some embodiments, the inner workings of the node 13, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the WD 22 via the network node 16 and/or node 13, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as ProSe unit 34, and restriction unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

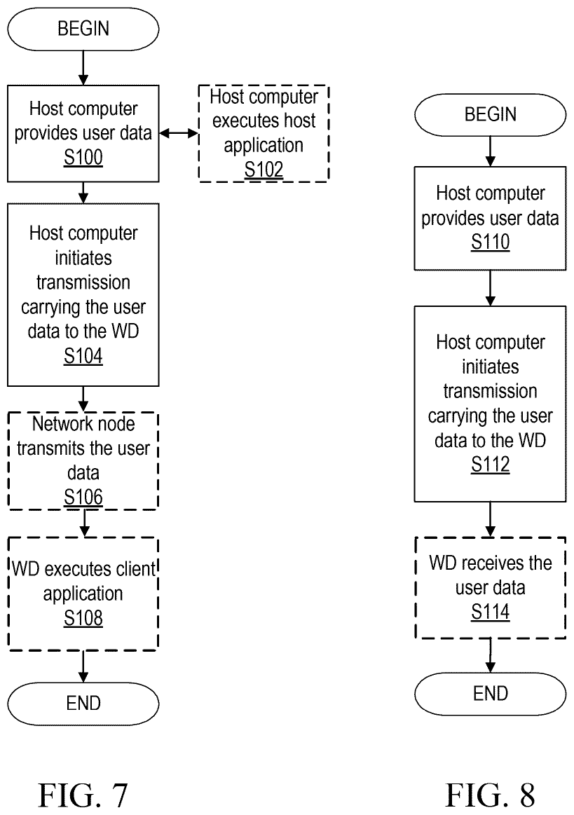

FIG. 7 is a flowchart illustrating an example method implemented in a communication system, such as, for example, the communication system of FIGS. 5 and 6, in accordance with one embodiment. The communication system may include one or more of host computer 24, a network node 16, node 13 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include one or more of a host computer 24, a network node 16, node 13 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

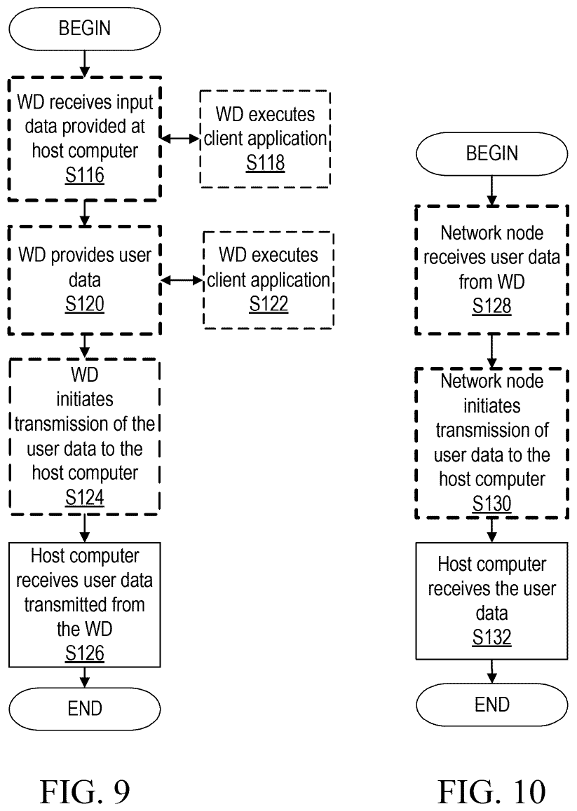

FIG. 9 is a flowchart illustrating an example method implemented in a communication system, such as, for example, the communication system of FIG. 5, in accordance with one embodiment. The communication system may include one or more of host computer 24, a network node 16, node 13 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

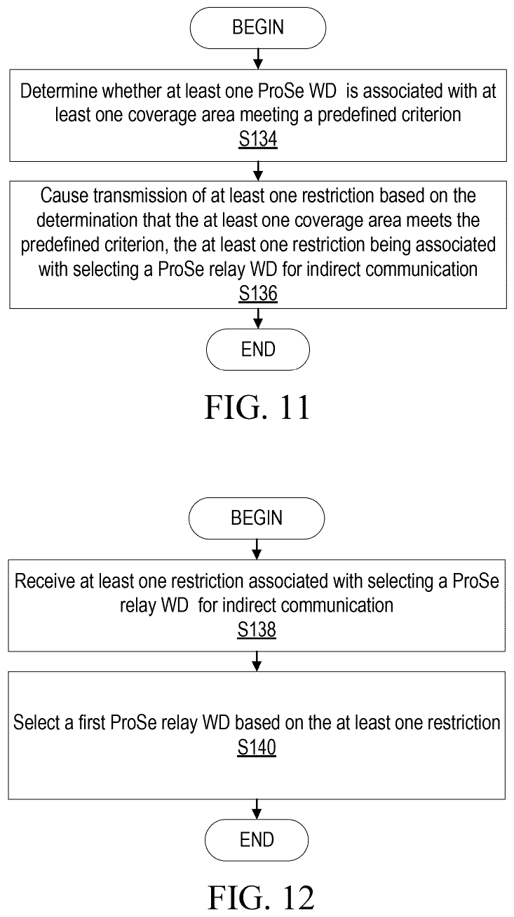

FIG. 11 is a flowchart of an example process in node 13 according to some embodiments of the present disclosure. One or more blocks described herein may be performed by one or more elements of node 13 such as by one or more of processing circuitry 96 (including the restriction unit 32), processor 98 and/or communication interface 94. Node 13 is configured to determine (Block S134) whether at least one ProSe UE (i.e., WD 22) is associated with at least one coverage area meeting a predefined criterion, as described herein.

Node 13 is configured to cause (Block S136) transmission of at least one restriction based on the determination that the at least one coverage area meets the predefined criterion, the at least one restriction being associated with selecting a ProSe relay UE (i.e., WD 22) for indirect communication, as described herein.

According to one or more embodiments, meeting the predefined criterion indicates the at least one coverage area meets a network congestion threshold. According to one or more embodiments, the at least one restriction restricts at least one ProSe relay UE (i.e., WD 22) in at least one congested coverage area from being selected by the remote UE (i.e., WD 22). According to one or more embodiments, the at least one restriction indicates the at least one coverage area where at least one ProSe relay UE (i.e., WD 22) is refrained from being used for indirect communication by the remote UE (i.e., WD 22).

According to one or more embodiments, the processing circuitry is further configured to monitor at least one coverage area and determine whether to one of generate and update the at least one restriction associated with selecting a ProSe relay UE (i.e., WD 22) for indirect communication. According to one or more embodiments, the monitoring includes receiving analytics from a network data analytics function, NWDAF, node about UE (i.e., WD 22) data congestion where the determination whether at least one ProSe UE (i.e., WD 22) is associated with the at least one coverage area meeting the predefined criterion being based at least on the received analytics. According to one or more embodiments, the node is a policy control function, PCF, node.

FIG. 12 is a flowchart of an example process in a UE (e.g., remote WD 22) according to some embodiments of the present disclosure. One or more blocks described herein may be performed by one or more elements of UE (i.e., WD 22) such as by one or more of processing circuitry 84 (including the ProSe unit 34), processor 86, radio interface 82 and/or communication interface 60. UE (i.e., WD 22) is configured to receive (Block S138) at least one restriction associated with selecting a ProSe relay UE (i.e., WD 22) for indirect communication, as described herein. UE (i.e., WD 22) is configured to select (Block S140) a first ProSe relay UE (i.e., WD 22) based on the at least one restriction, as described herein. According to one or more embodiments, the at least one restriction associated with selecting a ProSe relay UE (i.e., WD 22) is based on whether at least one coverage area associated with the at least one ProSe relay UE (i.e., WD 22) meets a predefined criterion. According to one or more embodiments, the at least one restriction restricts at least one ProSe relay UE (i.e., WD 22) in at least one congested coverage area from being selected for indirect communication by the remote UE (i.e., WD 22). According to one or more embodiments, the at least one restriction indicates at least one coverage area where at least one ProSe relay UE (i.e., WD 22) is refrained from being used for indirect communication by the remote UE (i.e., WD 22).

According to one or more embodiments, the processing circuitry being further configured to: receive an updated at least one restriction associated with selecting a ProSe relay UE (i.e., WD 22) for indirect communication; determine whether the first ProSe relay UE (i.e., WD 22) meets the updated at least one restriction; and perform at least one action based on the determination that the first ProSe relay UE (i.e., WD 22) meets the updated at least one restriction. In one or more embodiment, a ProSe relay UE (i.e., WD 22) meeting the restriction may correspond to the ProSe UE (i.e., WD 22) being within a restricted (e.g., congested) coverage area/location. According to one or more embodiments, the at least one action includes selecting a second ProSe relay UE (i.e., WD 22) that fails to meet the updated at least one restriction. According to one or more embodiments, the node is a policy control function, PCF, node.

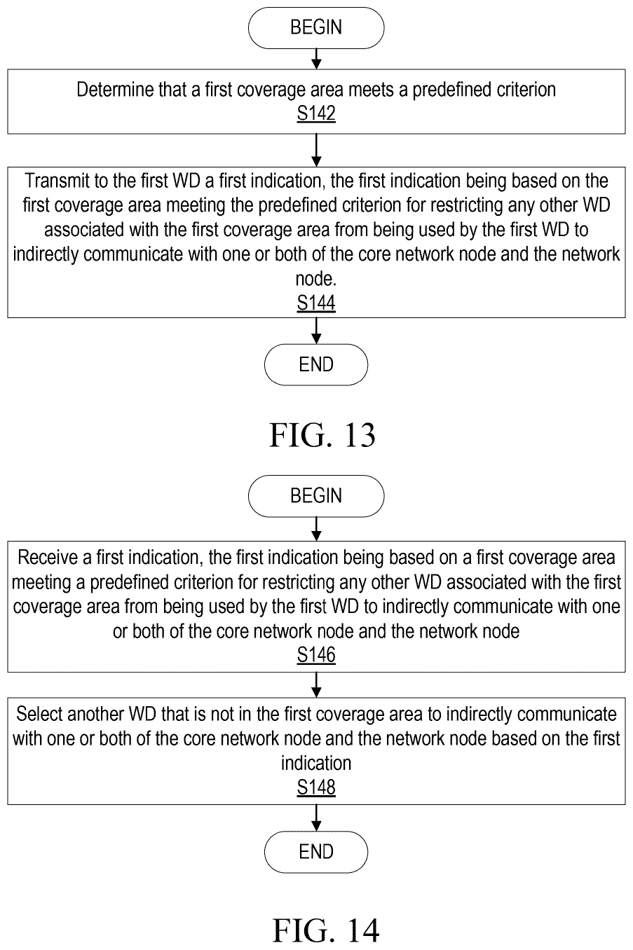

FIG. 13 is a flowchart of an example process (i.e., method) in node 13 according to some embodiments of the present disclosure. One or more blocks described herein may be performed by one or more elements of node 13 such as by one or more of processing circuitry 96 (including the restriction unit 32), processor 98 and/or communication interface 94. Node 13 is configured to determine (Block S142) that a first coverage area 18a meets a predefined criterion; and transmit (Block S144) to the first WD 16a a first indication, where the first indication is based on the first coverage area 18a meeting the predefined criterion for restricting any other WD 22 associated with the first coverage area 18a from being used by the first WD 22a to indirectly communicate with one or both of the core network node 13 and the network node 16.

In some embodiments, the method further comprises determining that a second coverage area 18b does not meet the predefined criterion. The first indication is transmitted further based on the determination that second coverage area 18b does not meet the predefined criterion. The first indication further enables the first WD 22a to indirectly communicate with one or both of the core network node 13 and the network node 16 via any other WD 22 associated with the second coverage area 18b.

In some other embodiments, the first indication triggers the first WD 22a to switch from a WD 22 currently being used as a relay WD by the first WD 22a in the first coverage area 18a to another WD 22 in the second coverage area 18b to be used by the first WD 22a as the relay WD to indirectly communicate with one or both of the core network node 13 and the network node 16.

In some embodiments, the method further comprises determining that the first WD 22a is authorized to use another WD 22 to indirectly communicate with one or both of the core network node 13 and the network node 16, determining one or more other WDs 22 have not been activated to perform relay communication, and determining a second indication that triggers the first WD 22a to activate relay communication via one or more other WDs 22 associated with the second coverage area 18b.

In some other embodiments, the method further includes transmitting the second indication to the first WD 22a, the second indication further indicating that data is to be transmitted outside a packet data unit (PDU) session, using the activated indirect communication.

In some embodiments, meeting the predefined criterion comprises reaching or exceeding a network congestion threshold.

In some other embodiments, the first indication further indicates at least the first coverage area as a restricted location for WDs 22 to perform relay communication.

In some embodiments, the core network node 13 is a policy control function (PCF) node, the network node 16 is an access network node, the first WD 22a is a remote WD, and the first WD 22a and the at least one other WD 22 are configured to communicate using Proximity-based Services (ProSe).

In some other embodiments, the method further comprises transmitting a third indication different from the first indication to at least one other WD 22 in the first coverage area 18a to trigger the at least one other WD 22 to stop performing relay communication.

In some embodiments, the method further comprises receiving network congestion analytics from a network data analytics function (NWDAF) node 106. The determination that the first coverage area 18a meets the predefined criterion is based at least on the received network congestion analytics.

FIG. 14 is a flowchart of an example process (i.e., method) in a WD 22 (e.g., remote WD 22) according to some embodiments of the present disclosure. One or more blocks described herein may be performed by one or more elements of WD 22 such as by one or more of processing circuitry 84 (including the ProSe unit 34), processor 86, radio interface 82 and/or communication interface 60. WD 22 is configured to receive (Block S146) a first indication, where the first indication is based on a first coverage area 18a meeting a predefined criterion for restricting any other WD 22 associated with the first coverage area 18a from being used by the first WD 22a to indirectly communicate with one or both of the core network node 13 and the network node 16, and select (Block S148) another WD 22 that is not in the first coverage area 18a to indirectly communicate with one or both of the core network node 13 and the network node 16 based on the first indication.

In some embodiments, the first indication is further based on a determination that a second coverage area 18b does not meet the predefined criterion. The first indication further enables the first WD 22a to indirectly communicate with one or both of the core network node 13 and the network node 16 via any other WD 22 associated with the second coverage area 18b.

In some other embodiments, the method further comprises switching, based on the first indication, from a WD 22 currently being used as a relay WD by the first WD 22a in the first coverage area 18a to another WD 22 in the second coverage area 18b to be used by the first WD 22a as the relay WD to indirectly communicate with one or both of the core network node 13 and the network node 16.

In some embodiments, the first WD 22a is authorized to use another WD 22 to indirectly communicate with one or both of the core network node 13 and the network node 16, one or more other WDs 22 have not been activated to perform relay communication, and the method further comprises receiving a second indication that triggers the first WD 22a to activate relay communication via one or more other WDs 22 associated with the second coverage area 18b and activating the relay communication via the one or more other WDs 22 associated with the second coverage area 18b based on the second indication.

In some other embodiments, the second indication further indicates that data is to be transmitted outside a packet data unit (PDU) session, using the activated indirect communication.

In some embodiments, meeting the predefined criterion comprises reaching or exceeding a network congestion threshold.

In some other embodiments, the first indication further indicates at least the first coverage area 18a as a restricted location for WDs 22 to perform relay communication.

In some embodiments, the core network node 13 is a policy control function (PCF) node, the network node 16 is an access network node, the first WD 22a is a remote WD, and the first WD 22a and the at least one other WD 22 are configured to communicate using Proximity-based Services (ProSe).

In some other embodiments, the method further comprises receiving a third indication different from the first indication to at least one other WD 22 in the first coverage area 18a to trigger the at least one other WD 22 to stop performing relay communication.

In some embodiments, the first coverage area 18a meeting the predefined criterion is based on network congestion analytics determined by a network data analytics function (NWDAF) node 106.

Having described the general process flow of arrangements of the disclosure and having provided examples of hardware and software arrangements for implementing the processes and functions of the disclosure, the sections below provide details and examples of arrangements for ProSe relay (ProSe relay WD 22) selection, configuration, etc.

In one or more embodiments, the term network is used and may refer to any node such as a core node (e.g., PCF), a network node (e.g., an access network node), etc. One or more embodiments provide for ProSe relay selection, configuration, etc.

One or more WD 22 functions described herein may be performed by one or more of processing circuitry 84, processor 86, ProSe unit 34, etc. One or more node 13 (e.g., PCF/H-PCF/PCT node) functions described herein may be performed by one or more of processing circuitry 96, processor 98, restriction unit 32, etc. In one or more embodiments, node 13 may be located outside the core network 14.

One advantage of 5G ProSe WD-to-Network Relay is to enable indirect communication between the 5GC network and WDs that are out of coverage of the network, e.g., as a way to extend the network coverage. When the network enables such indirect communication (e.g., by sending an URSP update with ProSe Relay offload indication) the WD 22 first discovers other WDs 22 (e.g., the available ProSe Layer-3 WD-to-Network Relay WDs 22) and then selects one WD 22 to establish the indirect communication. Conventional technology does not allow for the network to prioritize the selection of the ProSe layer-3 WD-to-Network Relay WDs 22.

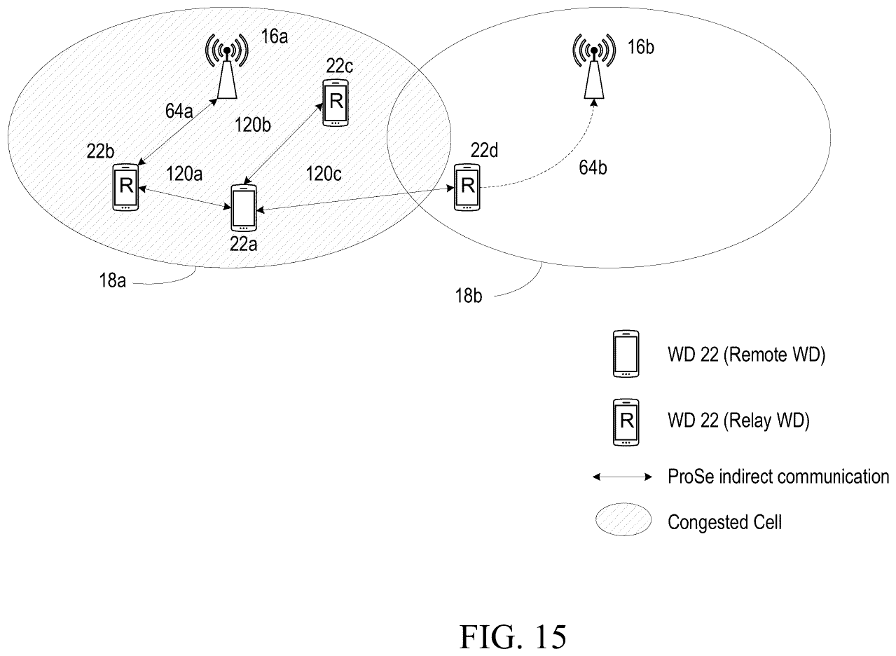

FIG. 15 shows two network nodes 16 (e.g., access network nodes), a first WD 22a, a second WD 22b, a third WD 22c, and a fourth WD 222d. WD 22a is a remote WD, and WDs 22b-22d are relay WDs. WD 22 may communicate with WDs 22b, 22c, 22d using sidelinks 120a, 120b, 120c, respectively.

When a conventional network enables ProSe indirect communication for a remote WD (e.g., WD 22a) which is in a congested area 18a, the network does not include any information to WD 22a (e.g., the remote WD) to select a relay WD 22 (e.g., ProSe Relay WD) which is in a different not congested cell. When using conventional networks that enable ProSe indirect communication, there are no guarantees that the remote WD 22 selects a ProSe Relay WD 22 out of the same congested cell. That is, if WD 22a (e.g., remote WD) selects any of WDs 22b, 22c (e.g., ProSe Relay WDs) in the same congested cell, WD 22a suffers the congestion problem since WDs 22b, 22c (ProSe Relay WDs) access the network over the congested cell.

In one or more embodiments of the present disclosure, WD 22a (e.g., remote WD) selects WD 22d (e.g., the ProSe Relay in the non-congested cell). In other words, WD 22a (e.g., the remote WD) skips the congestion and/or is not directly exposed to the congestion in the cell.

In some embodiments, 5G ProSe WD-to-Network Relay can be also applied for remote WDs (e.g., WD 22a) that are under direct network coverage (Uu). In some other embodiments, the network (e.g., node 13 such as via network node 16) may indicate (by URSP update with ProSe Relay offload indication) to WD 22a (e.g., the remote WD) that the way to access to the core network 14 (e.g., 5GC network) is by indirect communication by using 5G Prose WD-to-Network Relay through a WD ProSe Relay (instead of using direct communication through Uu). This way, it enables a mechanism for path switching from 5GC Uu path to PC5 ProSe Relay or vice versa.

In some embodiments, the network (e.g., node 13, network node 16) then may apply path switching from wireless connection 64 (e.g., 5GC Uu) to sidelink 120 (e.g., PC5 ProSe Relay) to the WDs 22 that are in a congested coverage area 18 (e.g., experiencing Uu congestion) in order to skip the congestion in wireless connection 64a. Conventional systems cannot guarantee a relay WD 22 (e.g., that the ProSe Relay WD) that is selected is outside of the congested area 18a.

One or more embodiments provide a mechanism that is based on one or more of the following:
The PCF, also referred to as PCF node (e.g., node 13), monitors the areas under congestion by receiving analytics from NWDAF (e.g., NWDAF 106) about “User Data Congestion” and then using this information to generate URSP updates to the ProSe Remote WDs 22 in the congested area. This enables the ProSe indirect communication though ProSe Relay WDs 22 located in a non-congested cell.
An extension of URSP ProSe Relay offload indication to enable node 13 (e.g., the PCF) to provide the restricted locations for the ProSe Relay WDs 22 to use with ProSe indirect communication.
The WD 22 enforces the URSP Rule provided by node 13 (e.g., the PCF), then performs discovery of candidates for ProSe Relay WDs 22. The candidate WDs may be filtered to those in the new location included in ProSe Relay offload indication in the URSP Rule. That is WDs in a congested coverage area can be filtered out.
The node 13 (e.g., the PCF) tracks the location of the relay WDs 22 either via policy control request trigger (PCRT) provision in an AMF 104 or via subscription to analytics in NWDAF 106 on “WD mobility” and “User Data Congestion.” If a relay WD 22 is in a congested area, or will be in a congested area, node 13 (e.g., the PCF) may update the ProSe policy, so that the WD 22 does not act (e.g., avoids acting) as relay WD 22 in the congested coverage area 18.

### URSP ProSe Relay Offload Indication Extension

One or more embodiments described herein extend URSP information with the following information:

TABLE 2
URSP content including relay offload restricted locations route and
selection validation criteria. The acronym UE may refer to WD.

| | | | PCF | |
|---|---|---|---|---|
| | | | permitted | |
| Information | | | to modify | |
| name | Description | Category | in URSP | Scope |
| Route | Determines the order | Mandatory | Yes | UE |
| Selection | in which the Route | (NOTE 1) | | context |
| Descriptor | Selection Descriptors | | | |
| Precedence | are to be applied. | | | |
| Route | This part defines the | Mandatory | | |
| selection | route selection | (NOTE 2) | | |
| components | components | | | |
| SSC Mode | One single value of | Optional | Yes | UE |
| Selection | SSC mode. | | | context |
| | (NOTE 5) | | | |
| Network | Either a single value | Optional | Yes | UE |
| Slice | or a list of values of | (NOTE 3) | | context |
| Selection | S-NSSAI(s). | | | |
| DNN | Either a single value | Optional | Yes | UE |
| Selection | or a list of values of | | | context |
| | DNN(s). | | | |
| PDU Session | One single value of | Optional | Yes | UE |
| Type | PDU Session Type | (NOTE 8) | | context |
| Selection | | | | |
| Non- | Indicates if the traffic | Optional | Yes | UE |
| Seamless | of the matching | (NOTE 4) | | context |
| Offload | application is to be | | | |
| indication | offloaded to non- | | | |
| | 3GPP access outside | | | |
| | of a PDU Session. | | | |
| ProSe Layer- | Indicates if the traffic | Optional | Yes | UE |
| 3 UE-to- | of the matching | (NOTE 4) | | context |
| Network | application is to be | | | |
| Relay | sent via a ProSe | | | |
| Offload | Layer-3 UE-to- | | | |
| indication | Network Relay | | | |
| | outside of a PDU | | | |
| | session. | | | |
| ProSe Layer- | Includes a list of | Optional | Yes | UE |
| 3 UE-to- | restricted locations to | | | context |
| Network | enable ProSe Layer-3 | | | |
| Relay | UE-to-Network | | | |
| Offload | Relay. It can only be | | | |
| restricted | included when the | | | |
| locations | previous IE is | | | |
| | included. | | | |
| Access Type | Indicates the | Optional | Yes | UE |
| preference | preferred Access | | | context |
| | Type (3GPP or non- | | | |
| | 3GPP or Multi- | | | |
| | Access) when the UE | | | |
| | establishes a PDU | | | |
| | Session for the | | | |
| | matching application. | | | |
| PDU Session | An indication shared | Optional | Yes | UE |
| Pair ID | by redundant PDU | | | context |
| | Sessions as described | | | |
| | in clause 5.33.2.1 of | | | |
| | TS 23.501 [2]. | | | |
| RSN | The RSN as described | Optional | Yes | UE |
| | in clause 5.33.2.1 of | | | context |
| | TS 23.501 [2]. | | | |
| Route | This part defines the | Optional | | |
| Selection | Route Validation | | | |
| Validation | Criteria components | | | |
| Criteria | | | | |
| (NOTE 6) | | | | |
| Time | The time window | Optional | Yes | UE |
| Window | when the matching | | | context |
| | traffic is allowed. The | | | |
| | RSD is not | | | |
| | considered to be valid | | | |
| | if the current time is | | | |
| | not in the time | | | |
| | window. | | | |
| Location | The UE location | Optional | Yes | UE |
| Criteria | where the matching | | | context |
| | traffic is allowed. The | | | |
| | RSD rule is not | | | |
| | considered to be valid | | | |
| | if the UE location | | | |
| | does not match the | | | |
| | location criteria. | | | |

(NOTE 1):
Every Route Selection Descriptor in the list may have a different precedence value.
(NOTE 2):
At least one of the route selection components may be present.
(NOTE 3):
When the Subscription Information contains only one S-NSSAI in UDR, the PCF needs not provision the UE with S-NSSAI in the Network Slice Selection information. The “match all” URSP rule has one S-NSSAI at most.
(NOTE 4):
If this indication is present in a Route Selection Descriptor, no other components may be included in the Route Selection Descriptor.
(NOTE 5):
The SSC Mode 3 may only be used when the PDU Session Type is IP.
(NOTE 6):
The Route Selection Descriptor is not considered valid unless all the provided Validation Criteria are met.
NOTE 7:
In this Release of specification, inclusion of the Validation Criteria in Roaming scenarios is not considered.
(NOTE 8):
When the PDU Session Type is “Ethernet” or “Unstructured”, this component shall be present. When the new “ProSe Layer-3 UE-to-Network Relay Offload restricted locations” is included together with “ProSe Layer-3 UE-to-Network Relay Offload indication” this implies that the latter only applies in case the UE 22 finds a ProSe Layer-3 UE-to-Network Relay out of the restricted location.

### Relay ProSe WD 22 is Changed Upon Congestion

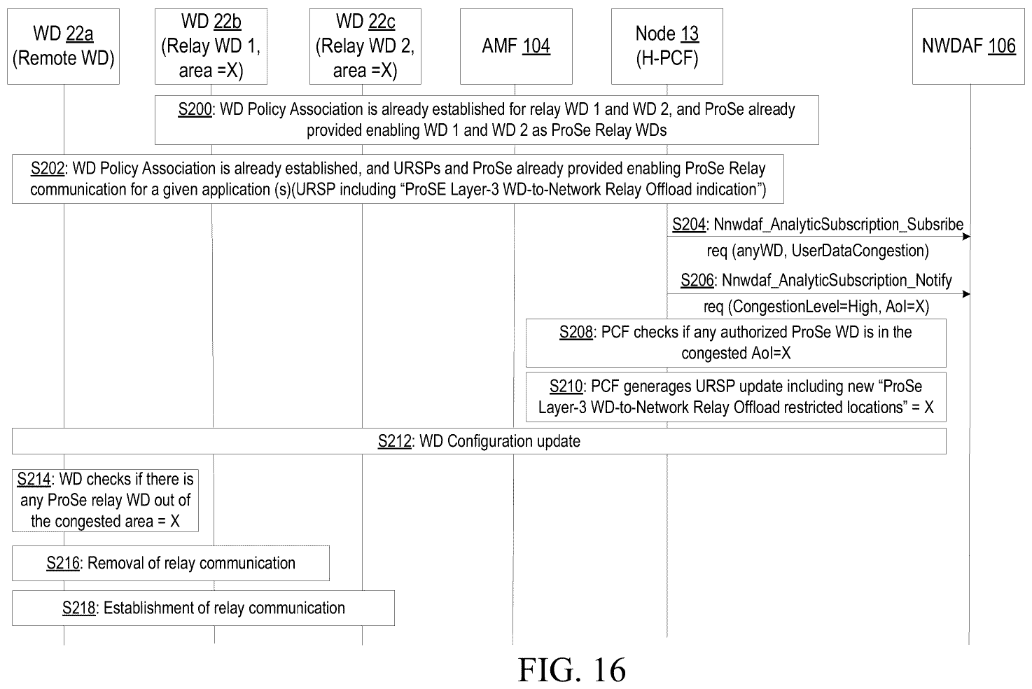

FIG. 16 shows a signaling diagram of an example selection of a relay WD 22 (e.g., relay ProSe WD that is changed) based on congestion. The selection may be performed to avoid the impacts that may appear in the transfer of the ProSe Relay traffic for some configured applications through ProSe Relay WDs 22 in a coverage area 18 is congested, e.g., by forcing the WD 22 to use a ProSe Relay out of that congested area 18.

In this nonlimiting example, it may be assumed that ProSe Relay communication is already authorized and activated for remote WDs 22 for one or several configured applications, i.e., ProSe policies for relay have been already delivered to the WDs 22 and URSP rules provided activating ProSe relay for one or several configured applications (e.g., software applications). Then, when node 13 (e.g., PCF) is notified that the coverage area 18 where the remote WDs 22 are located is congested, node 13 (e.g., PCF) determines to restrict the coverage area 18 for the ProSe Relay WD(s) 22 to use for that remote WD 22, e.g., by updating URSP rules for that WD 22. In some embodiments, a change of the ProSe Relay WD 22 to use indirect communication may be performed.

In one or more embodiments, described herein, when a URSP rule (e.g., an indication) is sent to a WD 22 (Remote WD 22) including “ProSe Layer-3 WD-to-Network Relay Offload restricted locations,” the URSP rule indicates to that WD 22 that the WD 22 cannot establish or refrains from establishing a connection with a ProSe Relay WD 22 if it the ProSe Relay WD 22 is in that location, e.g., restricted location. For the WDs 22 considered, the indication may include the identity of the location that is identified as congested.

As shown in FIG. 14, one or more of the following example steps may be performed.

S200: WD 22b (e.g., relay WD1) (in Area=X) and WD 22c (e.g., relay WD2) (in area !=X, i.e., an area that does not include Area=X) are registered in the network and enabled to act as ProSe Relay WDs 22.

S202: WD 22a (e.g., remote WD) is already registered in the network/network node 16/node 13 and provided with URSP and ProSe policies to enable the usage of ProSe Relay indirect communication for certain application(s).

S204: node 13 (e.g., PCF) determines to start monitoring the congestion in some areas of the network and sends Nnwdaf_AnalyticsSubscription_Subscribe request to NWDAF 106 for analytic “User Data Congestion.”

S206: NWDAF 106 notifies node 13 (e.g., PCF) about a level of congestion in a coverage area 18 (e.g., AoI=X) by sending Nnwdaf_AnalyticsSubscription_Notify.

S208: node 13 (e.g., PCF) checks if any WD 22 (e.g., remote WD) in the congested coverage area (AoI=X) has been authorized to use ProSe Relay. node 13 (e.g., PCF) may perform (or cause to perform) one or more of steps S210-S218 for one or more of the ProSe authorized WDs 22 in the congested coverage area 18.

S210: node 13 (e.g., PCF) generates a URSP update (e.g., a first indication) to include new “ProSe Layer-3 WD-to-Network Relay Offload restricted locations” with area=X for the URSP rules already downloaded including “ProSe Layer-3 WD-to-Network Relay Offload indication”.

S212: node 13 (e.g., PCF) invokes the procedure for WD Configuration Update to deliver the URSP update (including the new “ProSe Layer-3 WD-to-Network Relay Offload restricted locations” with area=X) to the WD 22a (e.g. remote WD 22).

S214: WD 22a stores the URSP update and then, in case a communication with a ProSe Relay WD 22b, 22c is already established. The WD 22a re-evaluates the selection of such ProSe Relay WD to skip those which are in the congested coverage area (Area=X) and selects one (e.g., one ProSe Relay WD) in the non-congested coverage area 18 (e.g., ProSe Relay WD 22b).

WD 22a (e.g., the remote WD) may obtain a time advance indicator (TAI) and/or coverage area identifier (e.g., the cell ID) of the relay WD 22 via an Additional parameter announcement procedure.

S216: WD 22a removes the relay communication towards WD 22b (e.g., ProSe Relay WD1 (in area=X)).

S218: WD 22a establishes a new relay communication towards WD 22c (e.g., ProSe Relay WD). WD 22a may start sending traffic for the application associated to the ProSe URSP through WD 22c which accesses the network over a non-congested coverage area.

### Relay ProSe Traffic is Activated Upon Congestion

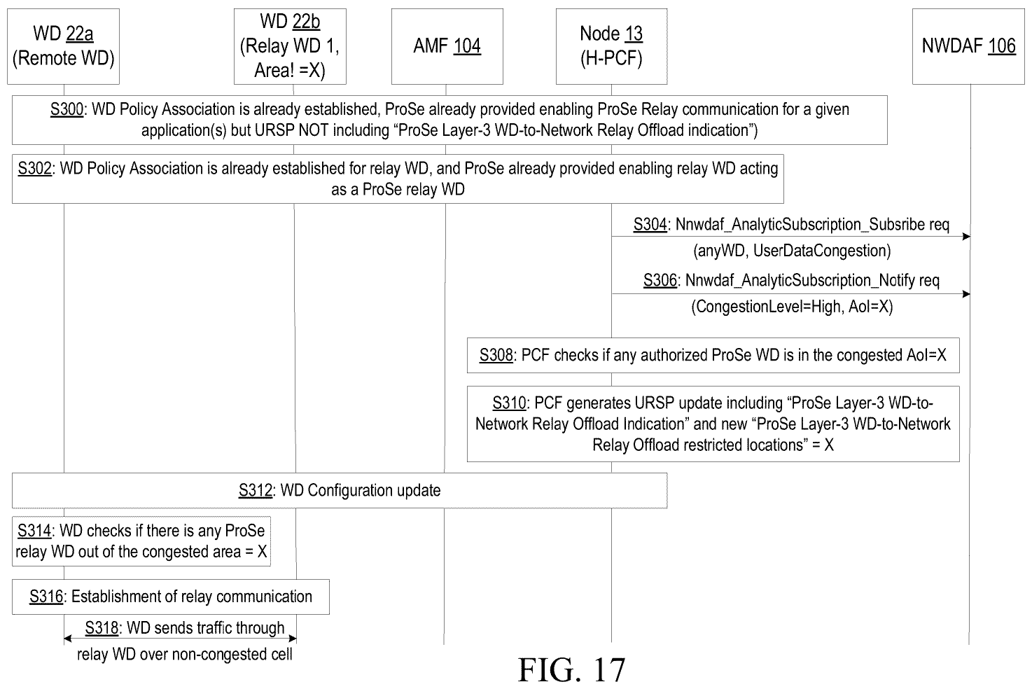

FIG. 17 is a signaling diagram another example selection of a relay WD 22 based on congestion. The selection may be performed to avoid the impacts that may appear in the transfer of traffic (through Uu) for some configured applications (e.g., software applications) in a congested coverage area 18, e.g., by enabling Uu to PC5 ProSe relay path switching and forcing the WD 22a to use a ProSe Relay WD 22 out of that congested coverage area 18.

When node 13 (e.g., PCF) is notified that a coverage area 18 is congested, node 13 (e.g., PCF) determines to activate ProSe Relay communication for one or more remote WDs 22 in the congested coverage area 18, e.g., for one or several configured applications such as by updating URSPs for one or more remote WDs 22.

As shown in FIG. 17, one or more of the following example steps may be performed.

S300: WD 22a (e.g., remote WD) is already registered in the network and the WD policy association is already established, enabling ProSe Relay communication for a given application(s). However, URSP does not include “ProSe Layer-3 WD-to-Network Relay Offload Indication.”

S302: WD 22b (e.g., relay WD (in Area!=X)) is registered in the network and enabled to act as ProSe Relay WD.

S304: node 13 (e.g., PCF) determines to start monitoring the congestion in some coverage areas 18 of the network. Node 13 (e.g., PCF) sends Nnwdaf_AnalyticsSubscription_Subscribe request to NWDAF 106 for analytic “User Data Congestion.”

S306: NWDAF 106 notifies PCF about a certain (e.g., predefined) level of congestion in a coverage area 18 (AoI=X) by sending Nnwdaf_AnalyticsSubscription_Notify.

S308: node 13 (e.g., PCF) checks if any WD 22 (WD 22a such as remote WD) in the congested coverage area 18 (AoI=X) has been authorized to use ProSe Relay. However, relay (i.e., relay communication) is not activated yet for configured applications, i.e., ProSe policies for relay have been already delivered but no URSP for the configured applications has been activated yet to use ProSe relay. Node 13 (e.g., PCF) performs or causes to perform one or more of steps S310-S318 for one or more authorized ProSe WDs 22 in the congested coverage area 18.

S310: node 13 (e.g., PCF) generates a URSP update to include “ProSe Layer3 WD-to-Network Relay Offload Indication” (e.g., second indication) and new “ProSe Layer-3 WD-to-Network Relay Offload restricted locations” with area=X (e.g., first indication).

S312: node 13 (e.g., PCF) invokes the procedure for WD Configuration Update to deliver the URSP update (including the new “ProSe Layer-3 WD-to-Network Relay Offload restricted locations” with area=X) to WD 22a (e.g., the remote WD 22).

S314: WD 22a stores the URSP update and selects WD 22b (e.g., a ProSe Relay WD 22 which is out of the congested area (Area=X)).

S316: WD 22a establishes a relay communication towards WD 22b (e.g., the selected ProSe Relay WD) out of the congested coverage area 18. The WD 22a may start sending traffic for the application associated to the ProSe URSP through WD 22b (ProSe Relay WD), which accesses the network over a non-congested coverage area 18.

### Update ProSe Policy to Enabling/Disabling Relay Service

In one or more embodiments, relay communication/service may be enabled o disabled at the relay WD 22, which may be similar to the example shown in FIG. 16 but restricting the usage of ProSe Relay WDs 22 which are in a congested coverage area 18. In some embodiments, the ProSe Policies for the ProSe Relay WDs that are in the congested area are updated to stop acting as relay WDs 22 (e.g., instead of updating the URSPs for a remote WD 22 to restrict the usage of ProSe Relay WDs 22 in the congested coverage area 18).

One or more embodiments provide information elements (IEs) in the ProSe policy: the areas (e.g., TAIs or cell IDs, or Geographical areas) and time slots where the relay WD 22 can or cannot act as relay, or a WD 22 can or cannot use the relay service. A method may include one or more steps, which may be described with respect to FIG. 17. More specifically, the method may include steps S300 and S302 of FIG. 17. Further, node 13 (e.g., PCF) may subscribe to AMF 104 with respect to the WD location using PCRT, and/or subscribe to WD mobility analytics/predictions to NWDAF 106. The method may further comprise steps S304 and S306 of FIG. 17. The method may further comprise node 13 (e.g., PCF) determining if any relay WD 22 is or will be in the congested coverage areas 18 in predicted time slots.

In addition, node 13 (e.g., PCF) may be configured to update the ProSe policy to the determined relay WDs 22 and to provide the areas (TAIs or cell IDs) where the relay WD 22 cannot act as relay.

Relay WD 22 may receive the policy update. If the relay WD 22 is already serving remote WD 22 in that area and timeslot, the relay WD 22 may stop the service by releasing the PC5 link with the releasing cause: “network congestion”.

Therefore, in one or more embodiments, a mechanism is provided that allows the network (PCF) to enable ProSe indirect communication for a remote WD 22 by adding location restrictions for the ProSe Relay WD 22 to use for the indirect communication. The network can restrict the ProSe indirect communication through the ProSe Relay WDs 22 that are located in the same congested cell as the Remote WD 22 and allow it for ProSe Relay WDs 22 that are in a non-congested cell.

In some embodiments, node 13 (e.g., PCF) can decide when a WD acting as a relay may continue acting as a relay WD or not. Node 13 (e.g., PCF) updates the ProSe policy to a WD located in a congested area so that it may not act as a relay.

Therefore, one or more embodiments described herein provide one or more of the following advantages:
Allows a mechanism for the network/node 13 to prioritize the usage of ProSe Relay WDs 22 which are in a non-congested coverage area 18, when enabling ProSe indirect communication.
Allows the network/node 13 to avoid performance impact in the transfer of traffic for WDs 22 in a congested coverage area 18 by enabling path switching from 5GC Uu in the congested cell to PC5 ProSe Relay through a relay WD 22 which is out of the congested cell.
Reduces the congestion level in a congested cell by offloading traffic of some WDs 22 from the congested cell to others which are non-congested.

According to one or more embodiments described herein, node 13 (e.g., PCF) may send the indication to the WDs 22 which are located in such congested location, to force the WDs 22 to use a ProSe Relay WD 22 which is out of the congested location. In some embodiments, for a remote WD 22, node 13 (e.g., PCF) may not know the location of the Relay WD 22 that is being used for the remote WD 22.

In some embodiments, node 13 (e.g., PCF) provides URSPs including “ProSe Layer-3 UE-to-Network Relay Offload indication” to the remote WD 22. In some other embodiments, the URSP delivery may occur if the WD is registered in the network (e.g., 5GC, either through a 3GPP or not 3GPP access). In some other embodiments, the URSPs are delivered through application management function (AMF) to the WD 22, e.g., over network access server (NAS) signaling.

The following is a nonlimiting list of example embodiments.

1. A node configured to communicate with a remote user equipment, UE, the node configured to, and/or comprising a radio interface and/or comprising processing circuitry configured to:
determine whether at least one ProSe UE is associated with at least one coverage area meeting a predefined criterion; and
cause transmission of at least one restriction based on the determination that the at least one coverage area meets the predefined criterion, the at least one restriction being associated with selecting a ProSe relay UE for indirect communication.

2. The node of Embodiment 1, wherein meeting the predefined criterion indicates the at least one coverage area meets a network congestion threshold.

3. The node of any one of Embodiments 1-2, wherein the at least one restriction restricts at least one ProSe relay UE in at least one congested coverage area from being selected by the remote UE.

4. The node of any one of Embodiments 1-3, wherein the at least one restriction indicates the at least one coverage area where at least one ProSe relay UE is refrained from being used for indirect communication by the remote UE.

5. The node of any one of Embodiments 1-4, the processing circuitry is further configured to:
monitor at least one coverage area; and
determine whether to one of generate and update the at least one restriction associated with selecting a ProSe relay UE for indirect communication.

6. The node of Embodiment 5, wherein the monitoring includes receiving analytics from a network data analytics function, NWDAF, node about UE data congestion, the determination whether at least one ProSe UE is associated with the at least one coverage area meeting the predefined criterion being based at least on the received analytics.

7. The node of any one of Embodiments 1-6, wherein the node is a policy control function, PCF, node.

8. A remote user equipment, UE, configured to communicate with a node, the remote WD configured to, and/or comprising a radio interface and/or processing circuitry configured to:
receive at least one restriction associated with selecting a ProSe relay UE for indirect communication; and
select a first ProSe relay UE based on the at least one restriction.

9. The remote UE of Embodiment 8, wherein the at least one restriction associated with selecting a ProSe relay UE is based on whether at least one coverage area associated with the at least one ProSe relay UE meets a predefined criterion.

10. The remote UE of any one of Embodiments 8-9, wherein the at least one restriction restricts at least one ProSe relay UE in at least one congested coverage area from being selected for indirect communication by the remote UE.

11. The remote UE of any one of Embodiments 8-10, wherein the at least one restriction indicates at least one coverage area where at least one ProSe relay UE is refrained from being used for indirect communication by the remote UE.

12. The remote UE of any one of Embodiments 8-11, wherein the processing circuitry being further configured to:
receive an updated at least one restriction associated with selecting a ProSe relay UE for indirect communication;
determine whether the first ProSe relay UE meets the updated at least one restriction; and
perform at least one action based on the determination that the first ProSe relay UE meets the updated at least one restriction.

13. The remote WD of Embodiment 12, wherein the at least one action includes selecting a second ProSe relay UE that fails to meet the updated at least one restriction.

14. The remote UE of any one of Embodiments 8-13, wherein the node is a policy control function, PCF, node.

15. A method implemented by a node configured to communicate with a remote user equipment, UE, the method comprising:
determining whether at least one ProSe UE is associated with at least one coverage area meeting a predefined criterion; and
causing transmission of at least one restriction based on the determination that the at least one coverage area meets the predefined criterion, the at least one restriction being associated with selecting a ProSe relay UE for indirect communication.

16. The method of Embodiment 15, wherein meeting the predefined criterion indicates the at least one coverage area meets a network congestion threshold.

17. The method of any one of Embodiments 15-16, wherein the at least one restriction restricts at least one ProSe relay UE in at least one congested coverage area from being selected by the remote UE.

18. The method of any one of Embodiments 15-17, wherein the at least one restriction indicates the at least one coverage area where at least one ProSe relay UE is refrained from being used for indirect communication by the remote UE.

19. The method of any one of Embodiments 15-18, further comprising:
monitoring at least one coverage area; and
determining whether to one of generate and update the at least one restriction associated with selecting a ProSe relay UE for indirect communication.

20. The method of Embodiment 19, wherein the monitoring includes receiving analytics from a network data analytics function, NWDAF, node about UE data congestion, the determination whether at least one ProSe UE is associated with the at least one coverage area meeting the predefined criterion being based at least on the received analytics.

21. The method of any one of Embodiments 15-20, wherein the node is a policy control function, PCF, node.

22. A method implemented by a remote user equipment, UE, configured to communicate with a node, the method comprising:
receiving at least one restriction associated with selecting a ProSe relay UE for indirect communication; and
selecting a first ProSe relay UE based on the at least one restriction.

23. The method of Embodiment 22, wherein the at least one restriction associated with selecting a ProSe relay UE is based on whether at least one coverage area associated with the at least one ProSe relay UE meets a predefined criterion.

24. The method of any one of Embodiments 22-23, wherein the at least one restriction restricts at least one ProSe relay UE in at least one congested coverage area from being selected for indirect communication by the remote UE.

25. The method of any one of Embodiments 22-24, wherein the at least one restriction indicates at least one coverage area where at least one ProSe relay WD is refrained from being used for indirect communication by the remote WD.

26. The method of any one of Embodiments 24-25, further comprising: receiving an updated at least one restriction associated with selecting a ProSe relay UE for indirect communication;
determining whether the first ProSe relay UE meets the updated at least one restriction; and
performing at least one action based on the determination that the first ProSe relay UE meets the updated at least one restriction.

27. The method of Embodiment 26, wherein the at least one action includes selecting a second ProSe relay UE that fails to meet the updated at least one restriction.

28. The method of any one of Embodiments 22-27, wherein the node is a policy control function, PCF, node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that May be Used in the Preceding Description Include:

| Abbreviation | Explanation |
|---|---|
| AF | Application Function |
| AMF | Access and Mobility Function |
| API | Application Programming |
| AS | Application Server |
| CP | Control Plane |
| DL | Downlink |
| DM | Data Management |
| DNN | Data Network Name |
| IE | Information Element |
| IMEI | International Mobile Equipment Identifier |
| IMSI | International Mobile Subscriber Identifier |
| IP | Internet Protocol |
| MBB | Mobile Broadband |
| MNO | Mobile Network Operator |
| NR | Next Generation Radio/New Radio |
| OAM | Operation Administration and Maintenance |
| PCC | Policy Charging and Control |
| PCEF | Policy and Charging Enforcement Function |
| PCF | Policy Control Function |
| PCRF | Policy Control Rules Function |
| PCRT | Policy Control Request Trigger |
| PDN | Packet Data Network |
| PEI | Permanent Equipment Identity |
| PGW | Packet Gateway |
| PGW-C | PDN Gateway Control plane function |
| PGW-U | PDN Gateway User plane function |
| ProSe | Proximity Services |
| PUI | Public User Identity |
| QoS | Quality of Service |
| RAN | Radio Access Network |
| SDF | Service Data Flow |
| SMF | Session Management Function |
| S-NSSAI | Single—Network Slice Selection Assistance |
| | Information |
| SPR | Subscriber Profile Repository |
| SUPI | Subscription Permanent Identifier |
| TCP | Transmission Control Protocol |
| TLS | Transport Layer Security |
| UDP | User Datagram Protocol |
| UDR | Unified Data Repository |
| UE | User Equipment |
| UL | Uplink |
| UP | User Plane |
| UPF | User Plane Function |
| URSP | UE Route Selection Policy |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A core network node configured to communicate with a first wireless device, WD, the first WD being configurable to indirectly communicate with one or both of the core network node and a network node at least via at least one other WD, the at least one other WD being configured to perform relay communication, the core network node comprising processing circuitry configured to:
determine that a first coverage area meets a predefined criterion;
cause transmission to the first WD of a first indication, the first indication being based on the first coverage area meeting the predefined criterion, for restricting any other WD associated with the first coverage area from being used by the first WD to indirectly communicate with one or both of the core network node and the network node; and
determine that a second coverage area does not meet the predefined criterion, the first indication being transmitted further based on the determination that the second coverage area does not meet the predefined criterion, the first indication further enabling the first WD to indirectly communicate with one or both of the core network node and the network node via any other WD associated with the second coverage area.

2. (canceled)

3. The core network node of claim 1, wherein the first indication triggers the first WD to switch from a WD currently being used as a relay WD by the first WD in the first coverage area to another WD in the second coverage area to be used by the first WD as the relay WD to indirectly communicate with one or both of the core network node and the network node.

4. The core network node of claim 1, wherein the processing circuitry is further configured to:
determine that the first WD is authorized to use another WD to indirectly communicate with one or both of the core network node and the network node;
determine one or more other WDs have not been activated to perform relay communication; and
determine a second indication that triggers the first WD (to activate relay communication via one or more other WDs associated with the second coverage area.

5. The core network node of claim 4, wherein the processing circuitry is further configured to:
cause transmission of the second indication to the first WD, the second indication further indicating that data is to be transmitted outside a packet data unit, PDU, session, using the activated indirect communication.

6. The core network node of claim 1, wherein meeting the predefined criterion comprises reaching or exceeding a network congestion threshold.

7. The core network node of claim 1, wherein the first indication further indicates at least the first coverage area as a restricted location for WDs to perform relay communication.

8. The core network node of claim 1, wherein the core network node is a policy control function, PCF, node, the network node is an access network node, the first WD is a remote WD, and the first WD and the at least one other WD are configured to communicate using Proximity-based Services, ProSe.

9. The core network node of claim 1, wherein the processing circuitry is further configured to:
cause transmission of a third indication different from the first indication to at least one other WD in the first coverage area to trigger the at least one other WD to stop performing relay communication.

10. The core network node of claim 1, wherein the processing circuitry is further configured to:
receive network congestion analytics from a network data analytics function, NWDAF, node, the determination that the first coverage area meets the predefined criterion being based at least on the received network congestion analytics.

11. A method in a core network node configured to communicate with a first wireless device, WD, the first WD being configurable to indirectly communicate with one or both of the core network node and a network node at least via at least one other WD, the at least one other WD being configured to perform relay communication, the method comprising:
determining that a first coverage area meets a predefined criterion;
transmitting to the first WD a first indication, the first indication being based on the first coverage area meeting the predefined criterion for restricting any other WD associated with the first coverage area from being used by the first WD to indirectly communicate with one or both of the core network node and the network node; and
determining that a second coverage area does not meet the predefined criterion, the first indication being transmitted further based on the determination that the second coverage area does not meet the predefined criterion, the first indication further enabling the first WD to indirectly communicate with one or both of the core network node and the network node via any other WD associated with the second coverage area.

12-20. (canceled)

21. A first wireless device, WD, configurable to indirectly communicate with one or both of a core network node and a network node at least via at least one other WD, the at least one other WD being configured to perform relay communication, the first WD comprising processing circuitry configured to:
receive a first indication, the first indication being based on a first coverage area meeting a predefined criterion for restricting any other WD associated with the first coverage area from being used by the first WD to indirectly communicate with one or both of the core network node and the network node; and
select another WD that is not in the first coverage area to indirectly communicate with one or both of the core network node and the network node based on the first indication,
wherein the first indication is further based on a determination that a second coverage area does not meet the predefined criterion, the first indication further enabling the first WD to indirectly communicate with one or both of the core network node and the network node via any other WD associated with the second coverage area.

22. (canceled)

23. The first WD of claim 21, wherein the processing circuitry is further configured to:
switch, based on the first indication, from a WD currently being used as a relay WD by the first WD in the first coverage area to another WD in the second coverage area to be used by the first WD as the relay WD to indirectly communicate with one or both of the core network node and the network node.

24. The first WD of claim 21, wherein the first WD is authorized to use another WD to indirectly communicate with one or both of the core network node and the network node, one or more other WDs have not been activated to perform relay communication, and the processing circuitry is further configured to:
receive a second indication that triggers the first WD to activate relay communication via one or more other WDs associated with the second coverage area; and
activate the relay communication via the one or more other WDs associated with the second coverage area based on the second indication.

25. The first WD of claim 24, wherein the second indication further indicates that data is to be transmitted outside a packet data unit, PDU, session, using the activated indirect communication.

26. The first WD of claim 21, wherein meeting the predefined criterion comprises reaching or exceeding a network congestion threshold.

27. The first WD of claim 21, wherein the first indication further indicates at least the first coverage area as a restricted location for WDs to perform relay communication.

28. The first WD of claim 21, wherein the core network node is a policy control function, PCF, node, the network node is an access network node, the first WD is a remote WD, and the first WD and the at least one other WD are configured to communicate using Proximity-based Services, ProSe.

29. The first WD of claim 21, wherein the processing circuitry is further configured to:
receive a third indication different from the first indication to at least one other WD in the first coverage area to trigger the at least one other WD to stop performing relay communication.

30. The first WD of claim 21, wherein the first coverage area meeting the predefined criterion is based on network congestion analytics determined by a network data analytics function, NWDAF, node.

31-40. (canceled)
